(19) United States
(12) Patent Application Publication
(10) Pub. No.: US 2026/0061915 A1
(43) Pub. Date: Mar. 5, 2026

(54) ROTARY LOCKING INDICATING MECHANISM AND CHILD SAFETY SEAT

(71) Applicant: WONDERLAND SWITZERLAND AG, Steinhausen (CH)

(72) Inventor: Xiaolong MO, Dongguan, Guangdong (CN)

(73) Assignee: WONDERLAND SWITZERLAND AG, Steinhausen (CH)

(21) Appl. No.: 19/106,102

(22) PCT Filed: Aug. 25, 2023
(86) PCT No.: PCT/EP2023/073335

§ 371 Date: Feb. 24, 2025

(30) Foreign Application Priority Data
Aug. 25, 2022 (CN) 202211029717.X
Sep. 30, 2022 (CN) 202211209988.3

(51) Int. Cl. B60N 2/90; B60N 2/28

(52) U.S. Cl. CPC B60N 2/933; B60N 2/2869; B60N 2002/952

(57) ABSTRACT

The present disclosure provides a child safety seat. The child safety seat includes: a base; a seat rotatably disposed on the base and having a forward-facing state and a backward-facing state with respect to the base; and an anti-misuse mechanism including a limiting groove disposed on the seat and a locking element disposed on the base, wherein the locking element is engaged with the limiting groove to prevent the seat from rotating from the backward-facing state to the forward-facing state, and wherein the locking element includes two limiting structures. The child safety seat provided by the present disclosure can prevent the seat from being wrongly rotated, and has high safety.

### TECHNICAL FIELD

The present disclosure relates to the field of children products, in particular to a rotary locking indicating mechanism and a child safety seat.

### BACKGROUND

Child safety seats refer to a kind of seats specially designed for children. The child safety seat can be installed in a vehicle for the children to sit thereon, so that the children can be restrained by the child safety seat to ensure their safety.

The existing child safety seat usually includes a base and a seat provided on the base, and an ISOFIX interface is directly disposed on one side of the base. A support leg may be further provided on the base to provide more firm fixation. In order to adapt to children of different ages, the seat may rotate relative to the base, thereby having a forward-facing state and a backward-facing state. Generally, the forward-facing state is suitable for old children, while the backward-facing state is suitable for younger children.

The forward-facing state is dangerous for younger children. However, the existing child safety seat does not provide a convenient anti-misuse mechanism to prevent the seat from being inadvertently rotated from the backward-facing state to the forward-facing state. Therefore, it is necessary to provide a child safety seat that can conveniently and reliably prevent the unintentional rotation.

With an increasing attention to the travel safety of children, the child safety seat has become an indispensable riding tool for children. In order to adapt to children of different ages or sizes, the child safety seat has two use states, namely, a forward-facing state and a backward-facing state. Generally, the child safety seat may be switched between the forward-facing state and the backward-facing state by rotating. However, in the existing child safety seat having forward and backward rotation functions, there is no corresponding instruction when it is rotated to the forward or backward-facing state, that is, when the user rotates the child safety seat to switch to the corresponding use state, it is impossible to clearly know whether the seat is rotated and clamped in place, which will affect the user experience and reduce the use safety. For example, if the user does not know whether the seat is clamped in place (i.e., the seat cannot be rotated when it is clamped), there may be a risk that the child safety seat will be rotated unintentionally during traveling of the vehicle due to a situation that the seat is not clamped in place.

Therefore, there is an urgent need for a rotary locking indicating mechanism that can enable users to know whether the child safety seat is rotated and clamped in place.

### SUMMARY

According to some embodiments, the child safety seats include: a base; a seat rotatably disposed on the base and having a forward-facing state and a backward-facing state with respect to the base; and an anti-misuse mechanism including a limiting groove disposed on the seat and a locking element disposed on the base, wherein the locking element is engaged with the limiting groove to prevent the seat from rotating from the backward-facing state to the forward-facing state, and wherein the locking element includes a limiting structure for limiting movement of the locking element with respect to the seat.

In addition to one or more of the features described herein, or as an alternative, further embodiments of the child safety seats may include that the anti-misuse mechanism includes two of the locking elements and two actuating elements corresponding to the two locking elements respectively, and the two locking elements are symmetrically disposed.

In addition to one or more of the features described herein, or as an alternative, further embodiments of the child safety seats may include that, one of the two actuating elements is actuated to prevent a corresponding one of the locking elements from being engaged with the limiting groove, thereby allowing the seat to rotate from the backward-facing state to the forward-facing state in one direction.

In addition to one or more of the features described herein, or as an alternative, further embodiments of the child safety seats may further include a rotary base, wherein the rotary base is formed in an annular shape and includes the limiting groove, two guiding inclined surfaces and an avoidance groove, wherein the two guiding inclined surfaces are disposed on both sides of the limiting groove, and both ends of the avoidance groove are respectively connected with outer sides of the two guiding inclined surfaces.

In addition to one or more of the features described herein, or as an alternative, further embodiments of the child safety seats may include that, one end of the locking element is provided with a limiting straight surface and an inclined surface, wherein the locking element is engaged with the limiting groove through the limiting straight surface to prevent the seat from rotating from the backward-facing state to the forward-facing state, and wherein the inclined surface is cooperated with one of the two guiding inclined surfaces to guide the locking element into the limiting groove during rotation of the seat from the backward-facing state to the forward-facing state.

In addition to one or more of the features described herein, or as an alternative, further embodiments of the child safety seats may include that, a rotary operating element is provided on each of both sides of the seat for being operated to rotate the seat with respect to the base.

In addition to one or more of the features described herein, or as an alternative, further embodiments of the child safety seats may include that, the limiting structure includes a first limiting structure and a second limiting structure, wherein the first limiting structure includes a first limiting hole and a first limiting element, and the second limiting structure includes a second limiting hole and a second limiting element.

In addition to one or more of the features described herein, or as an alternative, further embodiments of the child safety seats may include that, the first limiting element and the second limiting element respectively pass through the first limiting hole and the second limiting hole and are fixed to the base, so that the locking element is capable of only moving along one direction.

In addition to one or more of the features described herein, or as an alternative, further embodiments of the child safety seats may further include a restoring element, and two ends of the restoring element respectively abut against the first limiting hole and the first limiting element, so as to constantly apply a pushing force to the locking element moving towards the rotary base.

In addition to one or more of the features described herein, or as an alternative, further embodiments of the child safety seats may include that, the first limiting hole and the second limiting hole are both elongated holes, and extending directions of the first limiting hole and the second limiting hole are consistent with the one direction, and the first limiting element and the second limiting element are both screws.

In addition to one or more of the features described herein, or as an alternative, further embodiments of the child safety seats may include that, a rotary operating element is provided on each of both sides of the seat for being operated to rotate the seat with respect to the base.

In addition to one or more of the features described herein, or as an alternative, further embodiments of the child safety seats may further include a support leg and a sliding element telescopically disposed on the base, the support leg being pivotally connected to the sliding element and extended or retracted along with the sliding element; and a traction element configured to rotate the support leg from an unfolded position to a folded position, so as to pull the support leg to move towards the base.

In addition to one or more of the features described herein, or as an alternative, further embodiments of the child safety seats may include that, the traction element is a flexible element.

In addition to one or more of the features described herein, or as an alternative, further embodiments of the child safety seats may include that, the flexible member is a steel wire, a rope or a woven tape.

In addition to one or more of the features described herein, or as an alternative, further embodiments of the child safety seats may further include a driving element which pivots along with the support leg, wherein the driving element is configured to roll up the traction element to pull the support leg to move towards the base.

In addition to one or more of the features described herein, or as an alternative, further embodiments of the child safety seats may include that, the driving element is disposed on the support leg, and the driving element and the support leg form an integral structure and form a part of the support leg; alternatively, the driving element and the support leg are separately formed and are connected and fixed through a fixing structure.

In addition to one or more of the features described herein, or as an alternative, further embodiments of the child safety seats may include that, the driving element is located at an upper end of the support leg.

In addition to one or more of the features described herein, or as an alternative, further embodiments of the child safety seats may include that, the driving element is in a boss shape, and is provided with an arc part cooperated with the traction element; alternatively, the driving element is provided in a shape of a pulley; alternatively, the driving element is provided in a shape of a column.

In addition to one or more of the features described herein, or as an alternative, further embodiments of the child safety seats may include that, a first end of the traction element is connected with the base, and a second end of the traction element is connected with one of the driving element and the upper end of the support leg.

In addition to one or more of the features described herein, or as an alternative, further embodiments of the child safety seats may include that, an inner top wall of the base is provided with a fixing column, and the first end of the traction element is fixed on the fixing column through a first fastener.

In addition to one or more of the features described herein, or as an alternative, further embodiments of the child safety seats may further include a stroke amplifying mechanism having a first end connected with the base and a second end connected with the support leg through the traction element.

In addition to one or more of the features described herein, or as an alternative, further embodiments of the child safety seats may include that, the stroke amplifying mechanism is a rhombic telescopic frame.

In addition to one or more of the features described herein, or as an alternative, further embodiments of the child safety seats may include that, a fixing frame is disposed in the base, and a first end of the stroke amplifying mechanism is connected with the fixing frame through a second fastener.

In addition to one or more of the features described herein, or as an alternative, further embodiments of the child safety seats further include that, the seat is rotatably disposed on the base and has at least a forward-facing position and a backward-facing position, and the child safety seat has a first use mode in which the sliding element is extended and the support leg is unfolded to form a grounding support, and a second use mode in which the sliding element is retracted and the support leg is folded to a bottom of the base.

According to some embodiment, the present disclosure provides a rotary locking indicating mechanism for indicating whether the seat of a child safety seat rotatable relative to a base is positioned. The rotary locking indicating mechanism is disposed on the seat of the child safety seat, connected to the rotating locking mechanism for locking the seat to the base, and includes an unlocking operating element, an unlocking traction element and a state indicator. The unlocking operating element is slidably connected to the seat and capable of switching between a first position and a second position. One end of the unlocking traction element is connected to the unlocking operating element, and the other end of the unlocking traction element is connected to the rotary locking mechanism. The state indicator is disposed at least on the unlocking operating element for indicating a locking state of the seat with respect to the base. When the seat is locked to the base through the rotary locking mechanism, the unlocking operating element is located at the first position under an action of the unlocking traction element, and the state indicator indicates a first state; and when the unlocking operating element is operated to shift from the first position to the second position, the unlocking operating element drives the unlocking traction element to release the locking of the seat, and the state indicator indicates a second state.

In addition to one or more of the features described herein, or as an alternative, further embodiments of the rotary locking indicating mechanism may include that, the unlocking operating element is an unlocking button, and the unlocking button is movable from the first position to the second position by being pressed in a substantially vertical direction.

In addition to one or more of the features described herein, or as an alternative, further embodiments of the rotary locking indicating mechanism may further include an unlocking elastic reset element, one end of which is connected to the seat and the other end of which is connected to the unlocking operating element, the unlocking elastic reset element being configured to provide a force for driving the unlocking operating element to be in the second position, thereby pulling the unlocking traction element to tend to be away from the rotary locking mechanism.

In addition to one or more of the features described herein, or as an alternative, further embodiments of the rotary locking indicating mechanism may include that, the unlocking elastic reset element is a tension spring.

In addition to one or more of the features described herein, or as an alternative, further embodiments of the rotary locking indicating mechanism may include that when the seat is locked, a force exerted by the unlocking elastic reset element on the unlocking operating element and thus on the unlocking traction element is smaller than a locking force provided by the rotary locking mechanism.

In addition to one or more of the features described herein, or as an alternative, further embodiments of the rotary locking indicating mechanism may include that, the state indicator includes a first indicating element disposed on an outer surface of the unlocking operating element. When the seat is locked to the base, the unlocking operating element is kept at the first position by the unlocking traction element, and the first indicating element is exposed.

In addition to one or more of the features described herein, or as an alternative, further embodiments of the rotary locking indicating mechanism may include that, the state indicator further includes a second indicating element disposed on an outer surface of the seat. When the seat is locked to the base, the unlocking operating element shields the second indicating element; and when the unlocking operating element is operated to the second position, the first indicating element is shielded by the seat and the second indicating element is exposed. The first indicating element and the second indicating element display different indication information.

In addition to one or more of the features described herein, or as an alternative, further embodiments of the rotary locking indicating mechanism may further include a fixing element fixedly connected to the seat, the unlocking operating element being slidably disposed on the fixing element to slide between the first position and the second position with respect to the seat.

In addition to one or more of the features described herein, or as an alternative, further embodiments of the rotary locking indicating mechanism may include that, the state indicator includes a first indicating element, a second indicating element, an indicating window and an indicating bar. The indicating bar is fixedly disposed on the fixing element, the first indicating element and the second indicating element are sequentially disposed on the indicating bar in a vertical direction, and the indicating window is disposed on the unlocking operating element. When the unlocking operating element is located at the first position, the indicating window exposes the first indicating element; and when the unlocking operating element is located at the second position, the indicating window exposes the second indicating element. The first indicating element and the second indicating element display different indication information.

In addition to one or more of the features described herein, or as an alternative, further embodiments of the rotary locking indicating mechanism may include that, the indicating bar is integrally formed with the fixing element, and the first indicating element and the second indicating element present different colors.

In addition to one or more of the features described herein, or as an alternative, further embodiments of the rotary locking indicating mechanism may include that, the unlocking traction element is an unlocking steel wire.

In addition to one or more of the features described herein, or as an alternative, further embodiments of the rotary locking indicating mechanism may include that, the rotary locking mechanism is disposed on the seat and is capable of being engaged with a corresponding positioning hole on the base.

In addition to one or more of the features described herein, or as an alternative, further embodiments of the rotary locking indicating mechanism may include that, the positioning hole includes a forward positioning hole and a backward positioning hole. When the seat is in a forward-facing state, the rotary locking mechanism is engaged with the forward positioning hole; and when the seat is in a backward-facing state, the rotary locking mechanism is engaged with the backward positioning hole.

In addition to one or more of the features described herein, or as an alternative, further embodiments of the rotary locking indicating mechanism may include that, the rotary locking mechanism includes a fixing structure, a locking element and a traction element. The fixing structure is fixedly disposed on the seat, the fixing structure having an opened end. The locking element is disposed in the fixing structure, wherein the locking element is capable of sliding in the fixing structure, and one end of the locking element is configure to extend from the opened end of the fixing structure, so as to be engaged with the positioning hole. One end of the traction element is connected with the other end of the locking element, and the other end of the traction element is connected with the unlocking operating element of the rotating clamping indicating mechanism. When one end of the locking element extends out of the fixing structure and is engaged with the positioning hole, the unlocking operating element is in the first position under an action of the traction element, and when the unlocking operating element is operated to shift from the first position to the second position, the locking element is retracted into the fixing structure through the traction element.

In addition to one or more of the features described herein, or as an alternative, further embodiments of the rotary locking indicating mechanism may include that, the rotary locking mechanism further includes an elastic reset element disposed between the fixing structure and the locking element and constantly providing a force for driving one end of the locking element to extend out of the fixing structure.

In addition to one or more of the features described herein, or as an alternative, further embodiments of the rotary locking indicating mechanism may include that, the traction element and the unlocking traction element are integrated.

According to some embodiments, a rotary locking indicating mechanism for indicating whether a seat of a child safety seat rotatable relative to a base is positioned is provided. The rotary locking indicating mechanism is disposed on the seat and connected to a rotary locking mechanism for locking the seat to the base, and includes: an unlocking operating element, an unlocking traction element and a state indicator. The unlocking operating element is slidably connected to the seat and capable of switching between a first position and a second position. One end of the unlocking traction element is connected to the unlocking operating element, and the other end of the unlocking traction element is connected to the rotary locking mechanism. The state indicator is configured to indicate a rotary locking state of the seat with respect to the base. When the seat is locked to the base by the rotary locking mechanism, the unlocking operating element is located in the first position, and the state indicator is exposed; when the unlocking operating element is operated to shift from the first position to the second position, the unlocking operating element drives the unlocking traction element to release the locking of the seat, and the state indicator is shielded.

In addition to one or more of the features described herein, or as an alternative, further embodiments of the rotary locking indicating mechanism may include that, the state indicator includes a first indicating element, and the first indicating element is disposed on the unlocking operating element and exposed when the seat is locked to the base. When the locking between the seat and the base is released, the first indicating element is shielded by the seat along with movement of the unlocking operating element.

In addition to one or more of the features described herein, or as an alternative, further embodiments of the rotary locking indicating mechanism may include that, the state indicator further includes a second indicating element, and the second indicating element is disposed on the seat or the unlocking operating element and is shielded by the unlocking operating element when the seat is locked to the base. When the locking between the seat and the base is released, the second indicating element is exposed along with movement of the unlocking operating element.

According to some embodiments, child safety seats include a seat, a base, and a rotary locking indicating mechanism of any of the above embodiments. The seat is disposed on the base, and the rotary locking indicating mechanism is disposed at a side of the seat.

In addition to one or more of the features described herein, or as an alternative, further embodiments of the child safety seats may include that, two rotary locking indicating mechanisms are provided, and the two rotary locking indicating mechanisms are disposed on two sides of the seat respectively. The traction element of the rotary locking mechanism includes a first traction element and a second traction element. One end of the first traction element is connected to the locking element, and the other end of the first traction element is connected to one of the two rotary locking indicating mechanisms. One end of the second traction element is connected to the locking element, and the other end of the second traction element is connected to the other of the two rotary locking indicating mechanisms.

### BRIEF DESCRIPTION OF THE DRAWINGS

Various objects, features and advantages of the present disclosure will become more apparent by considering the following detailed description of preferred embodiments of the present disclosure in conjunction with the accompanying drawings. The drawings are only exemplary illustrations of the present disclosure and are not necessarily drawn to scale. In the drawings, the same reference numerals refer to the same or similar parts throughout. In the drawings:

FIG. 1 is a perspective view of a child safety seat of the present disclosure;

FIG. 2 is a rear perspective view of the child safety seat of the present disclosure;

FIG. 3 is a partial perspective view of the child safety seat of the present disclosure;

FIG. 4 is a perspective view of the child safety seat of the present disclosure, in which a seat is in a process of rotating from a backward-facing state to a forward-facing state;

FIG. 5 is a partial perspective view showing an internal structure of the child safety seat of the present disclosure, in which the seat is in a position shown in FIG. 4;

FIG. 6 is a perspective view of the child safety seat of the present disclosure, in which the seat is in the forward-facing state;

FIG. 7 is a partial perspective view showing the internal structure of the child safety seat of the present disclosure, in which the seat is in a position shown in FIG. 6;

FIG. 8 is a partial perspective view showing the internal structure of the child safety seat of the present disclosure, in which a locking element is engaged with a limiting groove;

FIG. 9 is a partial perspective view showing the internal structure of the child safety seat of the present disclosure, in which the locking element is not engaged with the limiting groove;

FIG. 10 shows a perspective view of the child safety seat in a forward-facing state according to an embodiment of the present disclosure;

FIG. 11 shows a perspective view of the child safety seat in a backward-facing state according to an embodiment of the present disclosure;

FIG. 12 shows a perspective view of a base of the child safety seat according to an embodiment of the present disclosure when viewed from a front side;

FIG. 13 shows a perspective view of the base of the child safety seat according to an embodiment of the present disclosure when viewed from a rear side;

FIG. 14a shows a cross-sectional view of the child safety seat in the forward-facing state according to an embodiment of the present disclosure;

FIG. 14b shows a partial enlarged view at a block A in FIG. 14a, in which the rotary locking mechanism is engaged with a forward positioning hole of the base;

FIG. 14c shows a view in which a locking element of the rotary locking mechanism is in a retracted state;

FIG. 15a shows a cross-sectional view of the child safety seat in a backward-facing state according to an embodiment of the present disclosure;

FIG. 15b shows a partial enlarged view at a block B in FIG. 15a, in which the rotary locking mechanism is engaged with a backward positioning hole of the base;

FIG. 16a shows a perspective view of the child safety seat according to an embodiment of the present disclosure, in which an upper surface of a seat is partially removed to show a locking fixing structure of the rotary locking mechanism;

FIG. 16b shows a partial enlarged view at a block C in FIG. 16a;

FIG. 16c shows a perspective view of an internal structure of the locking fixing structure shown in FIG. 16b;

FIG. 16d shows a perspective view of a traction element shown in FIG. 16c;

FIG. 17a shows a partial perspective view of the child safety seat in a locked state with respect to the base according to an embodiment of the present disclosure;

FIG. 17b shows a cross-sectional view taken along a line D-D in FIG. 17a;

FIG. 18a shows a partial perspective view of the child safety seat in a non-locked state with respect to the base according to an embodiment of the present disclosure;

FIG. 18b shows a cross-sectional view taken along a line E-E in FIG. 18a;

FIG. 19 shows a perspective view of an unlocking operating element of the rotary locking indicating mechanism according to an embodiment of the present disclosure;

FIG. 20 shows a perspective view of a lower cover of the seat according to an embodiment of the present disclosure;

FIG. 21a shows a partial perspective view of the child safety seat in the locked state with respect to a base according to another embodiment of the present disclosure;

FIG. 21b shows a cross-sectional view taken along a line F-F in FIG. 21a;

FIG. 22a shows a partial perspective view of the child safety seat in the non-locked state with respect to the base according to another embodiment of the present disclosure;

FIG. 22b shows a cross-sectional view taken along a line G-G in FIG. 22a;

FIG. 23 shows a perspective view of the unlocking operating element of the rotary locking indicating mechanism according to another embodiment of the present disclosure; and

FIG. 24 shows a perspective view of a fixing element of the rotary locking indicating mechanism according to another embodiment of the present disclosure.

### LIST OF REFERENCE NUMERALS

1 child safety seat
10 base
110 anchor portion
120 accommodating hole
130 rotary base
131 limiting groove
132 avoidance groove
133 guiding inclined surface
140 base upper cover
20 seat
210 rotary operating element
50 support leg
610 button
611 drive chute
612 guiding rib
620 locking element
621 protruding column
623 inclined surface portion
6231 limiting straight surface
6232 inclined surface
624 first limiting hole
625 second limiting hole
630 restoring element
640 first limiting element
650 second limiting element
1a child safety seat
100a seat
101a lower cover
102a rotary base
110a rotary locking mechanism
111a locking element
112a traction element
1121a first traction element
1122a second traction element
1123a connector
113a elastic reset element
114a fixing structure
115a screw
120a rotary locking indicating mechanism
121a unlocking operating element
122a unlocking traction element
1221a first unlocking traction element
1222a second unlocking traction element
123a unlocking elastic reset element
124a state indicator
1241a first indicating element
1242a second indicating element
1243a indicating window
1244a indicating bar
125a fixing element
126a screw
200a base
201a positioning hole
2011a forward positioning hole
2012a backward positioning hole

### DETAILED DESCRIPTION

In order to further illustrate the principle and structure of the present disclosure, the preferred embodiments of the present disclosure will be described in detail with the accompanying drawings. However, the embodiments are only for illustration and explanation, and cannot be used to limit the protection scope of the present disclosure.

The terminology used in the present disclosure is intended for the purpose of describing specific embodiments only and is not intended to limit the present disclosure. The singular forms “a”, “the” and “said”′ used in the present disclosure and the appended claims are also intended to include the plural forms, unless clearly indicated otherwise. It should also be understood that the expression “and/or” as used herein refers to and includes any or all possible combinations of one or more associated listed items.

The following is a more detailed description of the child safety seat and related various concepts and embodiments. A seat of the child safety seat may rotate between a backward-facing state, a lateral mode and a forward-facing state for convenient use. It should be understood that various concepts introduced above and discussed in more detail below can be implemented in various manners. Examples of specific embodiments and applications are mainly for illustrative purposes, so as to enable those skilled in the art to implement obvious embodiments and alternatives.

The child safety seat may be placed on a seat of the vehicle and fixed by an anchoring element to provide safety protection for children.

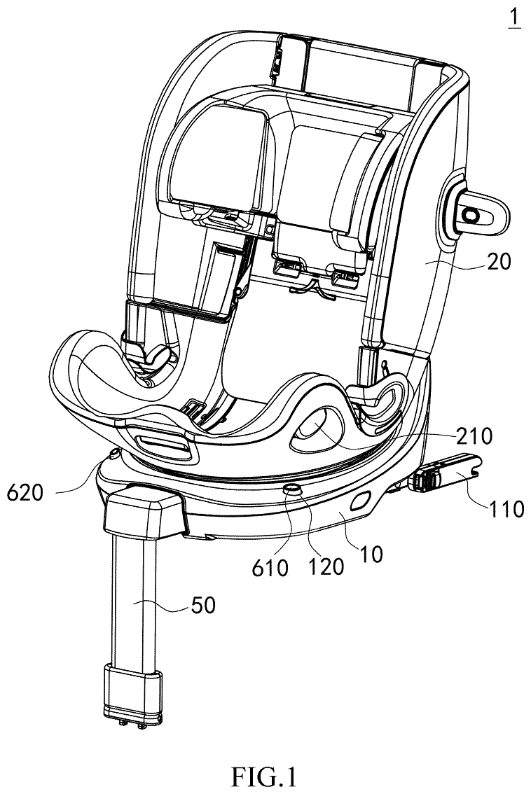

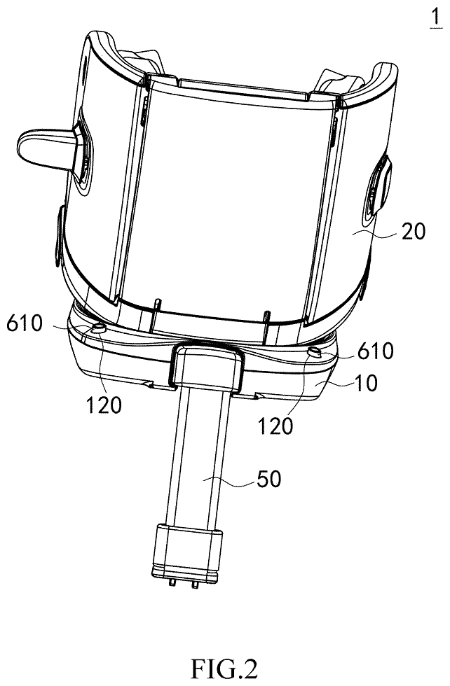

FIG. 1 is a perspective view of a child safety seat of the present disclosure, and FIG. 2 is a rear perspective view of the child safety seat of the present disclosure.

The child safety seat 1 of the present disclosure may include a base 10; a seat 20 rotatably disposed on the base 10 and having a forward-facing state and a backward-facing state with respect to the base 10; an anti-misuse mechanism including a limiting groove 132 disposed on the seat 20 and a locking element 620 disposed on the base 10. The locking element 620 may be engaged with the limiting groove 132 to prevent the seat 10 from rotating from the backward-facing state to the forward-facing state. The engagement of the locking element 620 with the limiting groove 132 is selective, and the locking element 620 may be operated to achieve engagement and disengagement with the limiting groove 132. This will be described in more detail below. The seat 10 may rotate by 360 degrees around the base 20.

The child safety seat 1 may further include an anchor portion 110 disposed at the rear of the base 10 and extending backwards; and a support leg 50 disposed at the front of the base 10 and extending downward. A lower end of the support leg 50 may abut against the floor of a compartment of the vehicle. The anchor portion 110 may be, for example, a fixing device for an ISOFIX interface, which may have two rigid arms disposed at both sides. The support leg 50 provide a third fixing point for the child safety seat 1, thereby better preventing a tendency that the child safety seat 1 is overturned when it is impacted. Optionally, the anchor portion 110 may be a fixing device for other interfaces, for example, lower anchors and tethers for children (LATCH) system and the like, and the present disclosure is not limited thereto.

In the present disclosure, the forward-facing state refers to that the seat 20 faces the front of the vehicle, and the backward-facing state refers to that the seat 20 faces the rear of the vehicle. In other words, when a child sits on the seat 20 in the forward-facing state, the child faces the front of the vehicle, and when the child sits on the seat 20 in the backward-facing state, the child faces the rear of the vehicle.

The anti-misuse mechanism is configured to prevent the seat 20 from being accidentally rotated from the backward-facing state to the forward-facing state. The above functions can be realized by performing at a certain position in the rotation process. Specifically, there may be a rotation threshold angle during the rotation of the seat 20 from the backward-facing state to the forward-facing state. The rotation threshold angle may be any angle within a range of 90° to 180°, for example, 100°, 110°, 120°, 130°, 140°, 150°, 160°and 170°. When the seat 20 is rotated to the rotation threshold angle, the locking element 620 may extend into and be engaged with the limiting groove 132, so that the seat 20 cannot be rotated further towards the forward-facing state. The locking element 620 may be actuated so that when the seat 20 is rotated to the rotation threshold angle, the locking element 620 will not be extended into the limiting groove 132. In this way, the seat 20 may be further rotated to the forward-facing state. Optionally, the rotation threshold angle may also refer to a plurality of angles, for example, two angles, three angles, and the like.

When the seat 20 is in the backward-facing state, the seat 20 may be rotated to the forward-facing state in a clockwise or counterclockwise direction. The anti-misuse mechanism may include two locking elements 620. The anti-misuse mechanism may further include two actuating elements 610 corresponding to two locking elements 620 one by one. The two locking elements 620 may be symmetrically disposed. Specifically, the two locking elements 620 may be symmetrically disposed on both sides of the base 10 at the front, but the present disclosure is not limited thereto.

A rotary operating element 210 may be provided on each of both sides of the seat 20. The rotary operating element 210 is configured to be operated to rotate the seat 20 with respect to the base 10. As shown in FIG. 1, two rotary operating elements 210 are symmetrically formed at the front of the seat, protruding upwards and having recesses recessed inward to form a shape similar to a handle. The two rotary operating elements 210 are convenient for manual operation to rotate the seat 20 with respect to the base 10 in the clockwise direction or the counterclockwise direction, respectively.

The base 10 may be formed with two accommodating holes 120 at positions corresponding to the two locking elements 620. The actuating element 610 may be a button. In other embodiments, the actuating element 610 may be a handle, a lever, or the like. The present disclosure does not limit the specific form of the actuating element 610.

The two actuating elements 610 may be disposed to protrude from the outer surface of the base 10 through the two accommodating holes 120, respectively, and may be actuated to protrude from the outer surface of the base 10 by a small distance, or may be actuated to be flush with the outer surface of the base 10.

Alternatively, the two actuating elements 610 may be disposed to be flush with the outer surface of the base 10 and may be actuated to be recessed into the base 10.

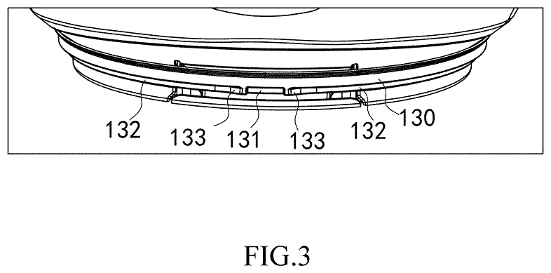

FIG. 3 is a partial perspective view of the child safety seat of the present disclosure, which shows a structure below the seat 20.

The seat 20 may include a rotary base 130. The rotary base 130 may be formed at a lower portion of the seat 20. The rotary base 130 may be generally formed in an annular shape, such as a circular ring. The rotary base 130 may include a limiting groove 131, two guiding inclined surfaces 133 and an avoidance groove 132.

The limiting groove 131 may be disposed at a position straight ahead of the seat 20, but the present disclosure is not limited thereto. The two guiding inclined surfaces 133 may be disposed at both sides of the limiting groove 131. Two ends of the avoidance groove 132 are respectively connected with outer sides of the two guiding inclined surfaces 133 respectively. That is, the avoidance grooves 132 are formed at all positions on an outer circumference of the rotary base 130 except for the two guiding inclined surfaces 133 and the limiting grooves 131, so as to surround most of the outer circumference of the annular rotary base 130. The avoidance groove 132 is configured to avoid the locking element 620. Thus, when the seat 20 is rotated with respect to the base 10, the avoidance groove 132 will not block the movement of the locking element 620. Each of the guiding inclined surfaces 133 is smoothly connected with the avoidance groove 132. Two side walls of the limiting groove 131 may protrude outward substantially perpendicular to the outer circumference surface of the rotary base 130. Each of the two guiding inclined surfaces 133 extends from one end of the avoidance groove 132 towards the limiting groove 131, so as to form a smooth transition structure between the avoidance groove 132 and the limiting groove 131.

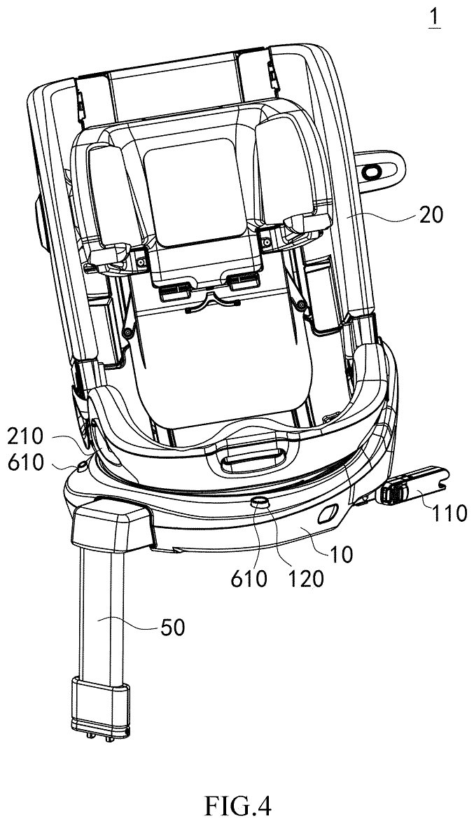

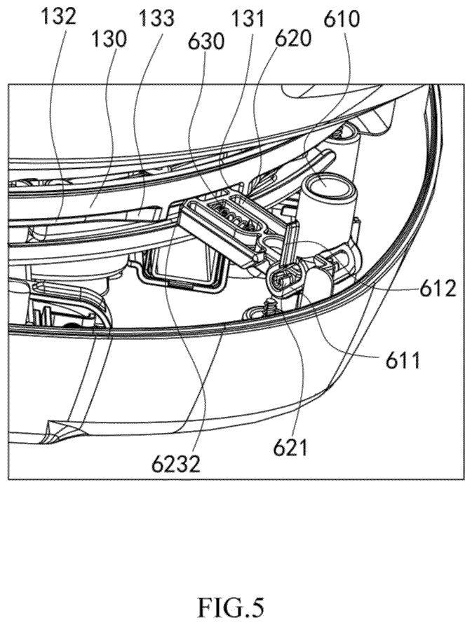

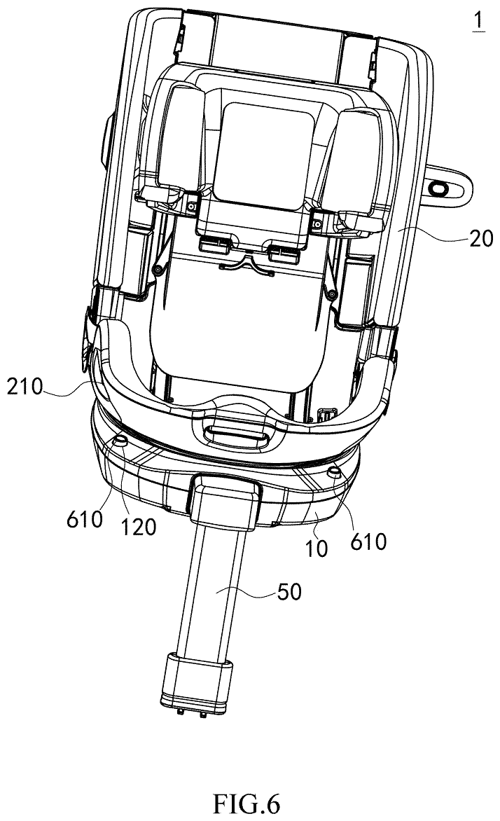

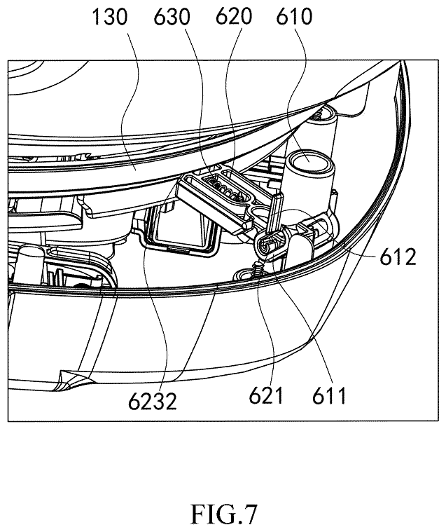

FIG. 4 is a perspective view of the child safety seat of the present disclosure, in which the seat is in a process of rotating from the backward-facing state to the forward-facing state, FIG. 5 is a partial perspective view showing an internal structure of the child safety seat of the present disclosure, in which the seat is in a position shown in FIG. 4, FIG. 6 is a perspective view showing the child safety seat of the present disclosure, in which the seat is in the forward-facing state, and FIG. 7 is a partial perspective view showing the internal structure of the child safety seat of the present disclosure, in which the seat is in a position shown in FIG. 6.

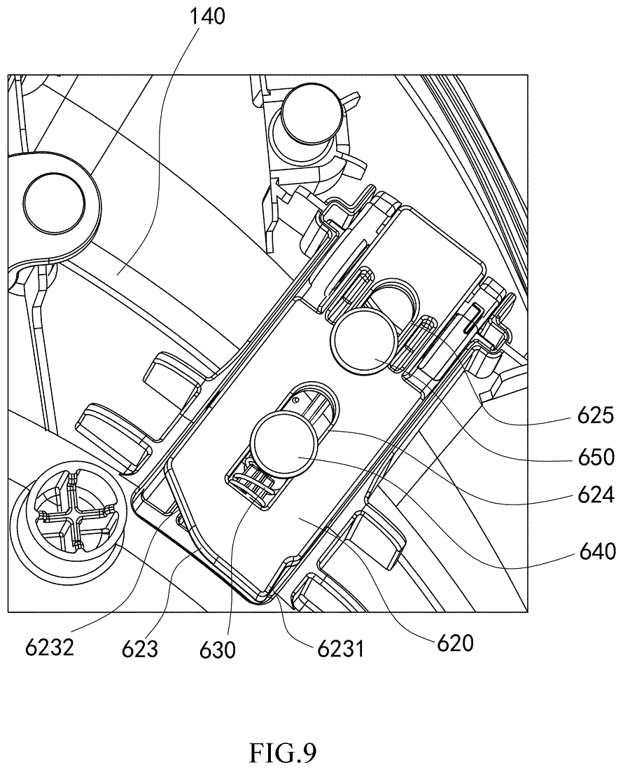

One end of the locking element 620 (i.e., an end facing towards the rotary base 130) is provided with an inclined surface portion 623, and the inclined surface portion 623 has a limiting straight surface 6231 and an inclined surface 6232 (see FIG. 9). The limiting straight surface 6231 may be formed as a recess on a side surface of the locking element 620. The inclined surface 6232 may be formed as an inclined surface connecting the side surface and an end surface of the locking element 620.

When the locking element 620 is engaged with the limiting groove 131, the limiting straight surface 6231 may abut against one side surface of the limiting groove 131 to prevent the seat 20 from rotating with respect to the base 10. That is, the locking element 620 is engaged with the limiting groove 131 through the limiting straight surface 6231 to prevent the seat 20 from rotating from the backward-facing state to the forward-facing state.

During the rotation of the seat 20 from the backward-facing state to the forward-facing state, when the actuating element 610 is not actuated, the inclined surface 6232 cooperates with the guiding inclined surface 133, so that the seat 20 may continue to be rotated, and at the same time, the guiding inclined surface 133 pushes the locking element 620 away from the rotary base 130 through the inclined surface 6232. That is, the inclined surface 6232 cooperates with one of the two guiding inclined surfaces 133 to guide the locking element 620 into the limiting groove 131 during the rotation of the seat 20 from the backward-facing state to the forward-facing state.

The actuating element 610 is formed with a drive chute 611. Preferably, two drive chutes 611 may be formed on the actuating element 610, and the two drive chutes 611 are oppositely disposed with respect to a movable direction of the locking element 620 towards the rotary base 130, so that the movement of the actuating element 610 is more stable. That is, a virtual connecting line formed by the two drive chutes 611 is perpendicular to a pushing direction of the locking element 620 towards the rotary base 130. One end of the locking element 620 (i.e., an end away from the rotary base 130) may be formed with a protruding column 621. The protruding column 621 protrudes transversely from both sides of the locking element 620 (i.e., protruding in a direction perpendicular to the movable direction of the locking element 620 towards the rotary base 130) and are inserted into the drive chute 611, so that the movement of the actuating element 610 along one direction (e.g., in a up and down direction) causes the locking element 620 to move along another direction (in a direction close to the rotary base 130 or a direction away from the rotary base 130, which may also be called “a radial direction of the rotary base 130”). Specifically, when the actuating element 610 is pressed down, the locking element 620 moves in the direction away from the rotary base 130. The drive chute 611 may be formed in an elongated shape, so that the protruding column 621 may move in the drive chute 611, and a length of the drive chute 611 is substantially equal to a stroke length of the locking element 620 moving in the direction away from the rotary base 130. The actuating element 610 may be disposed in a vertical direction, and the locking element 620 may be disposed in a horizontal direction. The drive chute 611 may be disposed to be inclined with respect to both the actuating element 610 and the locking element 620. For example, the drive chute 611 may be disposed to form an included angle of 45°with respect to both the actuating element 610 and the locking element 620. Alternatively, the drive chute 611 may be provided to form an included angle of less than 45°(for example, 30°) with respect to the actuating element 610, or the drive chute 611 may be provided to form an included angle of more than 45°(for example, 60°) with respect to the actuating element 610. The present disclosure does not limit an inclination angle of the drive chute 611.

A guiding rib 612 may be formed on the actuating element 610 or the locking element 620. The guiding rib 612 may be formed as a rib in a straight line shape protruding from a side portion of the actuating element 610 and the locking element 620. That is, a direction in which the guiding rib 612 protrudes outwards is a direction perpendicular to a direction in which the actuating element moves. Preferably, in this embodiment, two guiding ribs 612 may be formed on the actuating element 610 and the locking element 620, so that the movement of the actuating element 610 is more stable. The guiding rib 612 may be disposed above the drive chute 611 and may be vertical. The guiding rib 612 is configured to cooperate with a corresponding structure on the base 10 to define the actuating element 610 to move only in the vertical direction.

A plurality of holes may be formed on the actuating element 610 to reduce a weight of the actuating element 610 and an amount of materials used for manufacturing the actuating element 610.

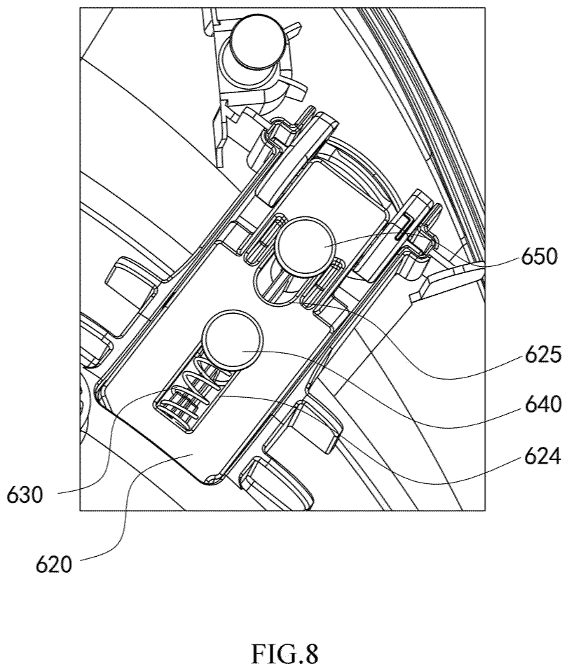

FIG. 8 is a partial perspective view showing the internal structure of the child safety seat of the present disclosure, in which the locking element is engaged with the limiting groove, and FIG. 9 is a partial perspective view showing the internal structure of the child safety seat of the present disclosure, in which the locking element is not engaged with the limiting groove.

The locking element 620 includes a limiting structure. Specifically, the locking element 620 may include two limiting structures, and the two limiting structures may include a first limiting structure and a second limiting structure. The first limiting structure may include a first limiting hole 624 and a first limiting element 640, and the second limiting structure may include a second limiting hole 625 and a second limiting element 650.

The first limiting hole 624 and the second limiting hole 625 are formed in an elongated shape along a radial direction of the rotary base 130, respectively. The first limiting hole 624 may be closer to the rotary base 130 than the second limiting hole 625. The first limiting element 640 and the second limiting element 650 may pass through the first limiting hole 624 and the second limiting hole 625 respectively and be fixed to the base 10, so that the locking element 620 can only move along the radial direction of the rotary base 130. That is, an axis of the first limiting element 640 and the second limiting element 650 is approximately perpendicular to a surface of the limiting groove of the rotary base 130. Similarly, a direction in which the first limiting hole 624 and the second limiting hole 625 extend is generally perpendicular to the surface of the limiting groove of the rotary base 130.

The child safety seat 1 may further include a restoring element 630. Two ends of the restoring element 630 may abut against the first limiting hole 624 and the first limiting element 640, respectively, so as to constantly apply a pushing force to the locking element 620 moving towards the rotary base 130. The restoring element 630 may be located in the first limiting hole 624. The first limiting hole 624 may have a sufficient length to accommodate the restoring element 630. The restoring element 630 may be a coil spring. Alternatively, the restoring element 630 may be another component that may provide a restoring force. Alternatively, two ends of the restoring element 630 may abut against the second limiting hole 625 and the second limiting element 650, respectively. The first limiting element 640 and the second limiting element 650 may be screws. Alternatively, the first limiting element 640 and the second limiting element 650 may be another component that may be fixed to the base 10 and extend into the first limiting hole 624 and the second limiting hole 625, respectively.

When the seat 20 is rotated from the backward-facing state to the forward-facing state, the locking element 620 moves along the avoidance groove 132. The avoidance groove 132 does not block the movement of the locking element 620. When the seat 20 is rotated to a position where the locking element 620 contacts with the guiding inclined surface 133, the guiding inclined surface 133 pushes the locking element 620 in the radial direction of the rotary base 130 and in the direction away from the rotary base 130 by means of the inclined surface 6232. Since the first limiting element 640 and the second limiting element 650 limit the first limiting hole 624 and the second limiting hole 625, the locking element 620 may only move accurately in the radial direction of the rotary base 130. Moreover, since the first limiting element 640 and the second limiting element 650 are limited at two positions, the locking element 620 will not swing or rotate itself during the movement. This enables the locking element 620 to smoothly extend and retract, thereby having excellent running quality. Since the locking element 620 is pushed away from the rotary base 130, the seat 20 may continue to rotate and the locking element 620 will not be blocked by a side wall of the limiting groove 131. When the seat 20 is rotated until the locking element 620 is aligned with the limiting groove 131, the restoring element 630 pushes the locking element 620 into the limiting groove 131. At this time, the seat cannot continue to rotate since the limiting straight surface 6231 abuts against the side wall of the limiting groove 131 (as shown in FIG. 5). A warning sign is posted on the actuating element 610. If the child safety seat is used for a child with a height within 0-105 cm or an age less than 15 months, it is recommended to use the forward-facing state, which may remind or provide reference for the operator to judge whether to press the actuating element 610 downward, so as to provide a warning action and prevent misuse. If the actuating element 610 needs to be pressed down, the downward movement of the actuating element 610 is transmitted to the locking element 620 through the cooperation of the drive chute 611 and the protruding column 621, so that the locking element 620 moves in the radial direction of the rotary base 130 and the direction away from the rotary base 130 against the restoring force of the restoring element 630. That is, the actuating element 610 makes the locking element 620 to leave the limiting groove 131. The operator may keep pressing the actuating element 610 downward and rotate the seat 20 at the same time until the locking element 620 passes through the limiting groove 131, then release the actuating element 610. Finally, the seat 20 may be continuously rotated to the forward-facing state.

It should be understood that the above process may also occur during the rotation of the seat 20 from the forward-facing state to the backward-facing state. Therefore, the child safety seat 1 of the present disclosure may also prevent the seat 20 from being accidentally rotated from the forward-facing state to the backward-facing state.

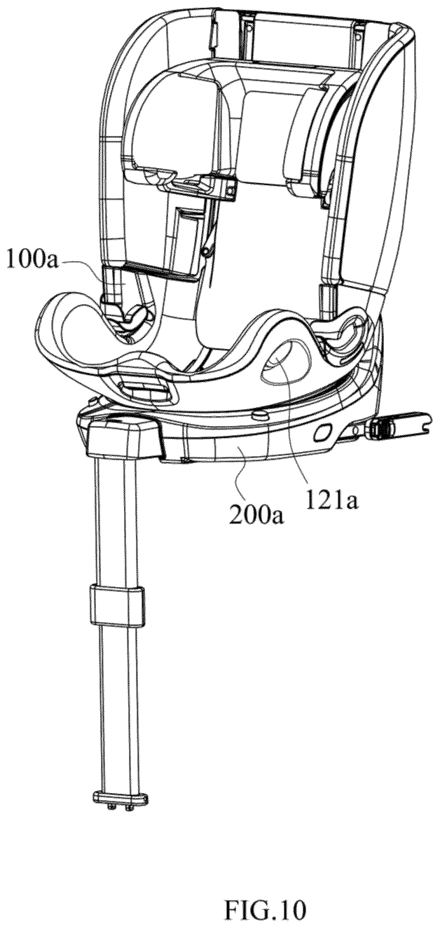

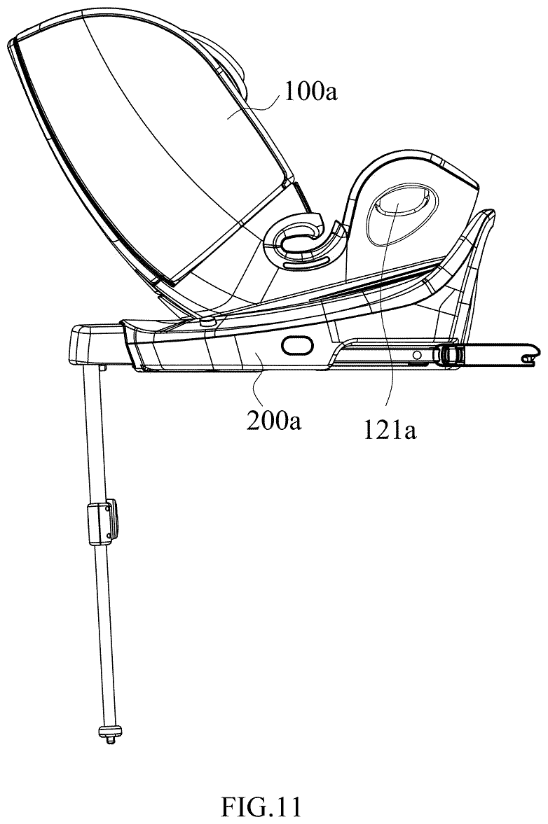

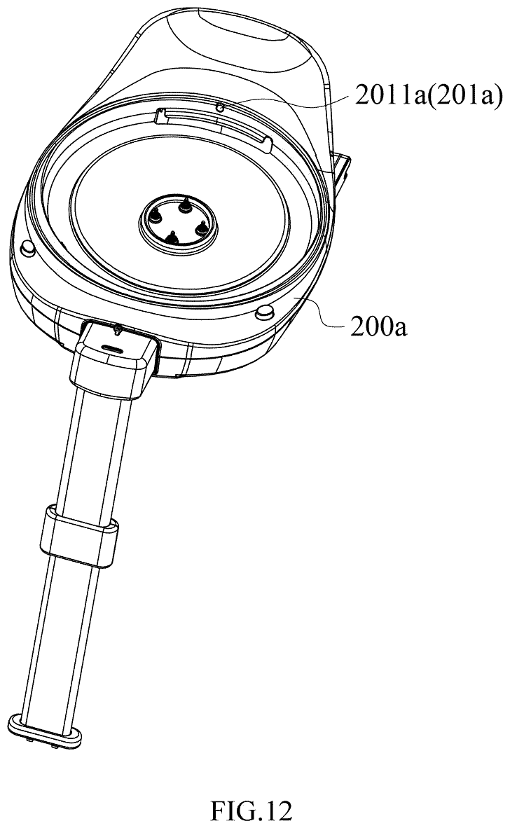

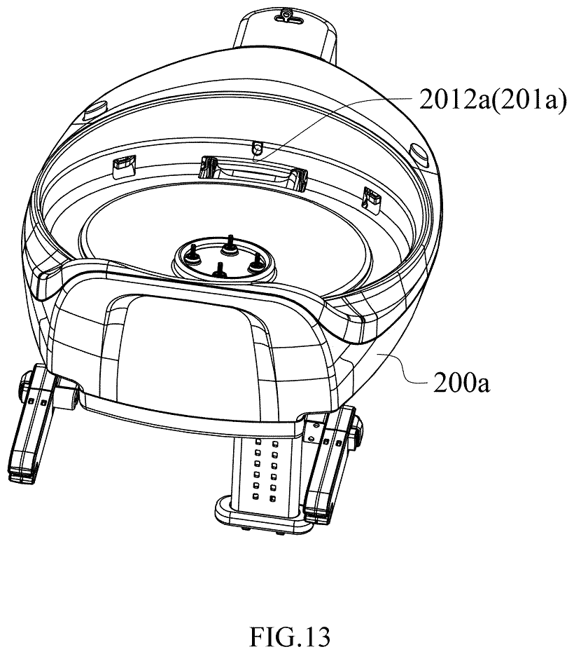

FIGS. 10 and 11 respectively show perspective views of the child safety seat in different use states, and FIGS. 12 and 13 respectively show perspective views of the base of the child safety seat viewed from the front side and the rear side.

As shown in FIGS. 10 and 11, an embodiment of the present disclosure provides a child safety seat la including a seat 100a and a base 200a, wherein the seat 100a is disposed on the base 200a. The child safety seat la has two use states: a forward-facing state (as shown in FIG. 10), i.e., it is disposed in a direction in which the vehicle moves forward; and a backward-facing state (as shown in FIG. 11), i.e., it is disposed in a direction opposite to the direction in which the vehicle moves forward. The child safety seat la of the present disclosure is switched between the forward-facing state and the backward-facing state by rotating the seat 100a with respect to the base 200a.

Specifically, the child safety seat la of the present disclosure includes a rotary locking mechanism 110a. The rotary locking mechanism 110a is disposed on the seat 200a, for example, directly behind the bottom of the seat 200a, and may be engaged with a positioning hole 201a correspondingly disposed on the base 200a, so as to realize the locking of the seat 100a with respect to the base 200a when the child safety seat la is rotated to a corresponding use state.

As shown in FIGS. 12 and 13, the positioning hole 201a includes a forward positioning hole 2011a and a backward positioning hole 2012a, and the forward positioning hole 2011a and the backward positioning hole 2012a may be respectively disposed on a center line of the base 200a in a transverse direction. When the seat 100a is in the forward-facing state, the rotary locking mechanism 110a is engaged with the forward positioning hole 2011a; and when the seat 100 is in the backward-facing state, the rotary locking mechanism 110a is engaged with the backward positioning hole 2012a.

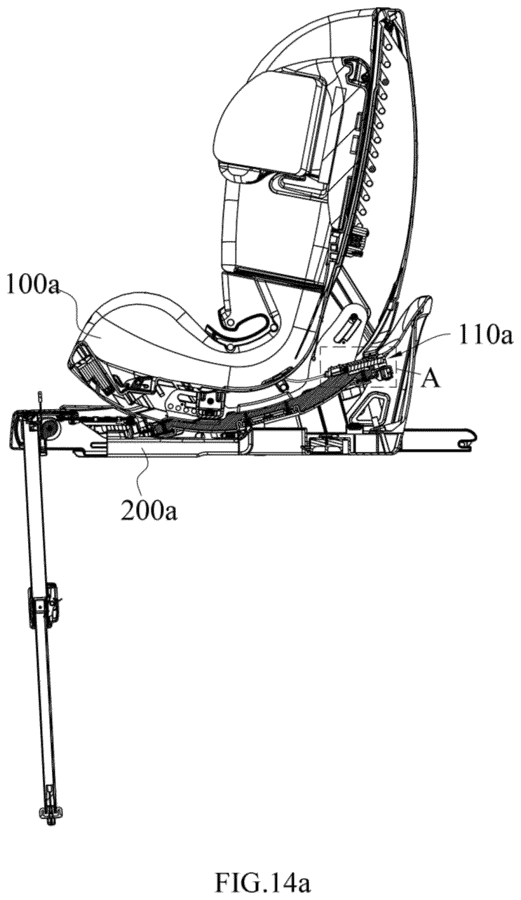

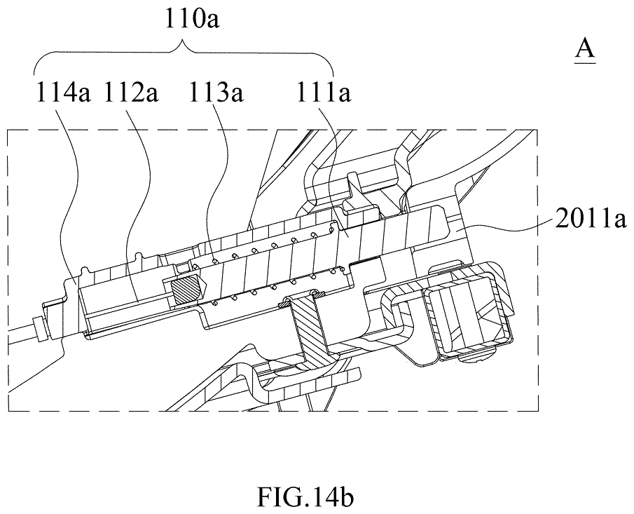

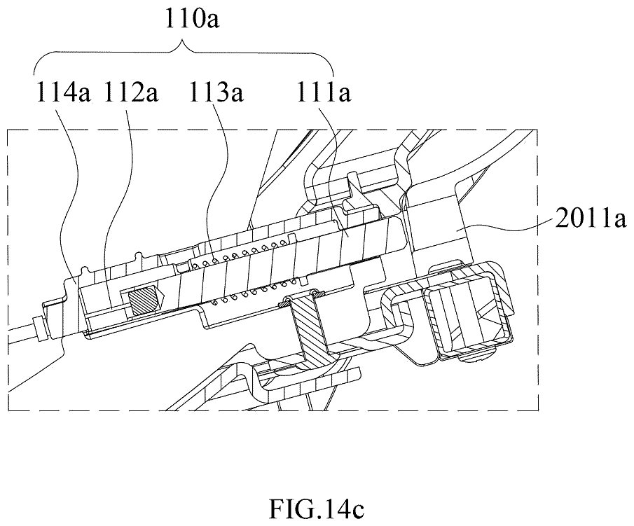

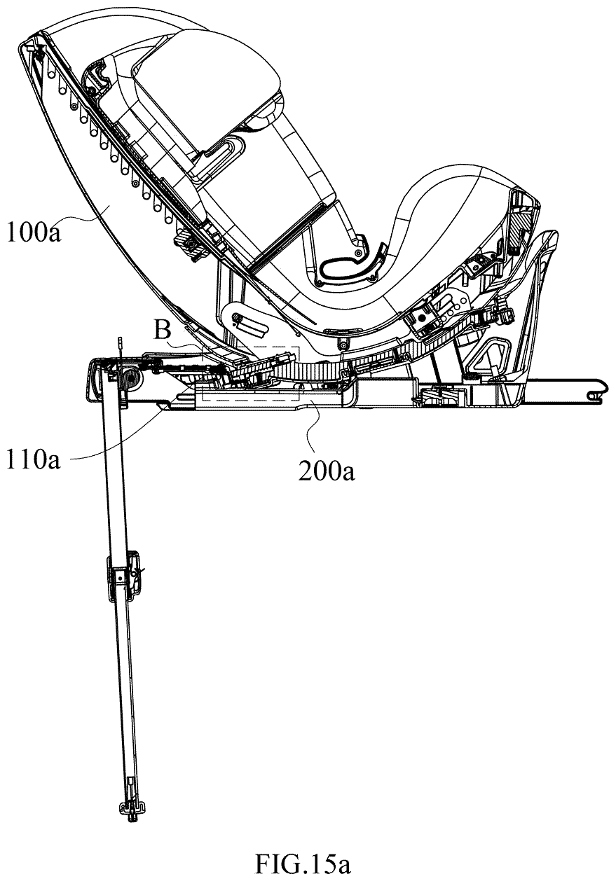

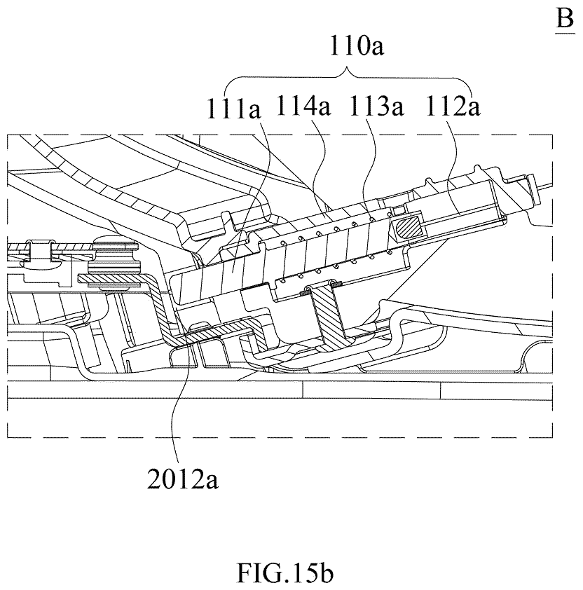

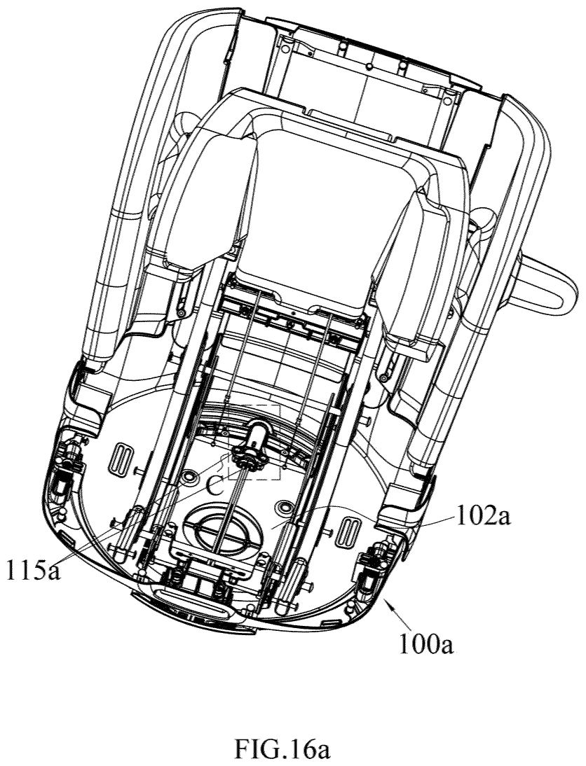

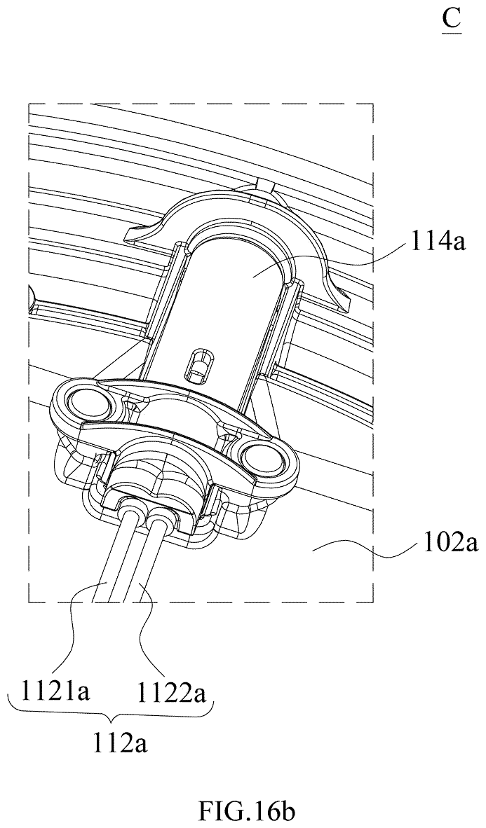

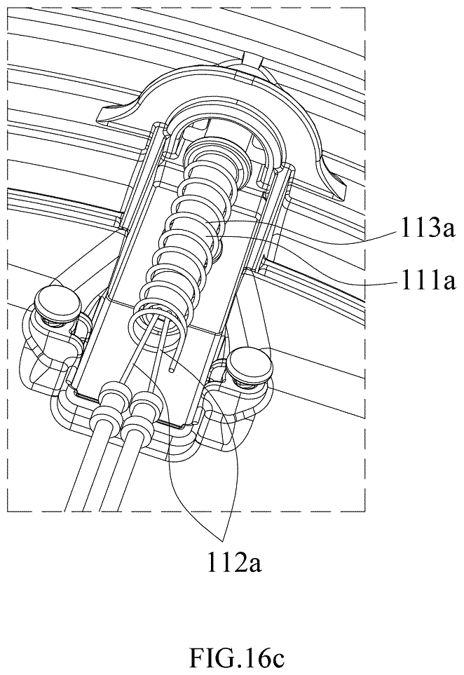

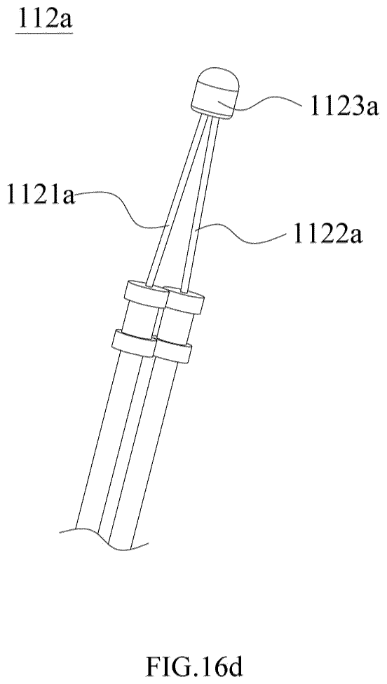

FIGS. 14a and 14b show the rotary locking mechanism when the child safety seat is in the forward-facing state, FIGS. 15a and 15b show the rotary locking mechanism when the child safety seat is in the backward-facing state, and FIGS. 16a to 16d respectively show a fixing structure and its internal structure.

In one embodiment, as shown in FIG. 14b, the rotary locking mechanism 110a includes a locking element 111a, a traction element 112a and a fixing structure 114a. The fixing structure 114a is fixedly disposed in the seat 100a, and one end of the fixing structure 114a is opened. For example, as shown in FIG. 16a, the fixing structure 114a may be fixedly disposed in the rotary base 102a of the seat 100a by screws 115a located at both sides of the fixing structure 114a to rotate with the seat 100a with respect to the base 200a, and the opened end thereof is cooperated with the forward positioning hole 2011a or the backward positioning hole 2012a. In one embodiment, the rotary base 102a may slide with respect to other parts of the seat 100a to adjust an inclination angle of the seat. In addition, in other embodiments, for example, in an embodiment without the rotary base 102a, the fixing structure 114a may also be directly fixed in the seat 100a.

Referring to FIGS. 14b and 15b, the locking element 111a is disposed in the fixing structure 114a and may slide in the fixing structure 114a, so that one end of the locking element 111a may extend from the opened end of the fixing structure 114a, thereby engaging with the forward positioning hole 2011a or the backward positioning hole 2012a. One end of the traction element 112a is connected with the other end of the locking element 111a, and the other end of the traction element 112a is connected with an unlocking device (for example, an unlocking operating element 121a which will be described in detail below). For example, the traction element 112a may be a steel wire, but the present disclosure is not limited thereto.

In one embodiment, an unlocking device (for example, an unlocking operating element 121a) may be disposed at each of both sides of the child safety seat la, and the traction element 112a of the rotary locking mechanism 110a may include a first traction element 1121a and a second traction element 1122a. As shown in FIG. 16d, one end of the first traction element 1121a and one end of the second traction element 1122a are connected together through a connector 1123a (for example, a steel wire head), and then connected with the locking element 111a through the connector 1123a, so that when any unlocking device on both sides of the child safety seat la is operated, the locking element 111a may be driven to realize synchronous adjustment.

In addition, as shown in FIGS. 14b, 15b and 16c, the rotary locking mechanism 110a may further include an elastic reset element 113a, which is disposed between the fixing structure 114a and the locking element 111a, and constantly provides a force to drive one end of the locking element 111a to extend out of the fixing structure 114a, so that when the seat 100a is rotated in place (i.e., to a position for forward use or backward use) and the unlocking device is not operated, the locking element 111a is always inserted into the positioning hole 201a to realize engagement. The elastic reset element 113a is, for example, a compression spring, but the present disclosure is not limited thereto.

With the above-mentioned structure, when the child safety seat la is in the forward-facing state, one end of the locking element 111a keeps extending out of the fixing structure 114a under the action of the elastic reset element 113a, and then extends out of a housing of the seat 100a to be engaged with the forward positioning hole 2011a of the base 200a, so that the seat 100a is locked to the base 200a and will not be rotated anymore; when there is a need to switch the child safety seat 1a from the forward-facing state to the backward-facing state, the traction element 112a is driven by the operation of the unlocking device, and then the protruding end of the locking element 112a is retracted into the fixing structure 114a by a pulling force of the traction element 112a, so that the seat 100a can be rotated to the backward-facing state with respect to the base 200a. During rotation, due to the position limitation of the inner housing of the base 200a on the locking element 111a, the locking element 111a is always kept in the retracted state until it reaches the position of the backward positioning hole 2012a, and under the action of the elastic reset element 113a, the locking element 111a extends out of the fixing structure 114a to be engaged with the backward positioning hole 2012a, thereby locking the seat 100a in the backward use position. In addition, in other embodiments, the locking element 111a may be kept in the retracted state after the unlocking device is operated and during the rotation of the seat 100a with respect to the base 200a by other means (for example, providing a holding mechanism for the unlocking device, a holding mechanism for the locking element, and cooperation between the unlocking device and the elastic element disposed at the locking element, etc.), so that the locking element 111a does not extend into the positioning hole 201a of the base 200a to a sufficient depth for engagement, as shown in FIG. 14c.

In order to present the locking condition of the seat 100a with respect to the base 200a, the child safety seat of the present disclosure further includes a rotary locking indicating mechanism 120a.

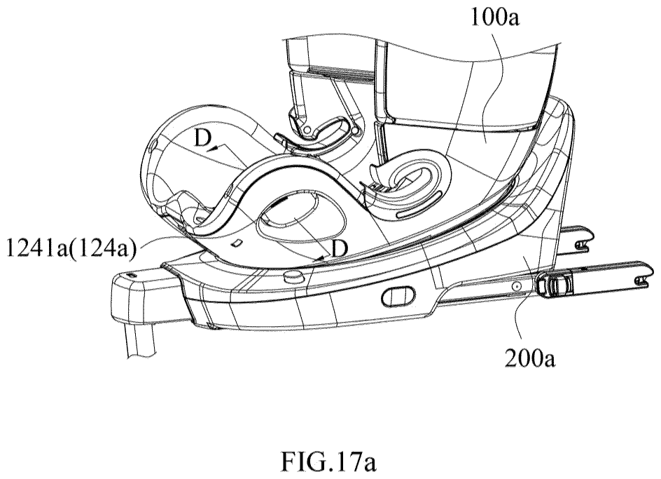

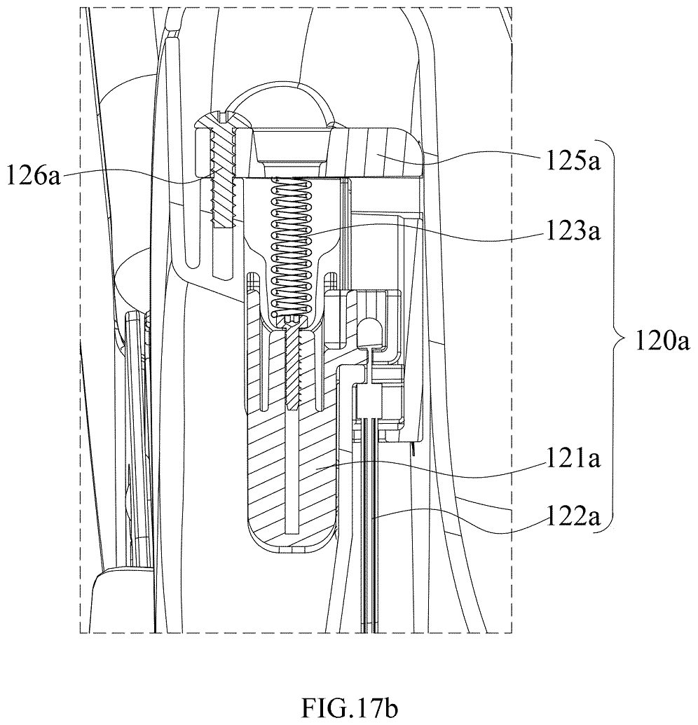

FIGS. 17a to 20 illustrate a rotary locking indicating mechanism according to an embodiment of the present disclosure.

In one embodiment of the present disclosure, as shown in FIGS. 17a to 20, the rotary locking indicating mechanism 120a is disposed on the seat 100a of the child safety seat and connected to the rotary locking mechanism 110a for locking the seat 100a to the base 200a, so as to indicate whether the seat 100a is positioned in place with respect to the base 200a. For example, the rotary locking indicating mechanism 120a may be disposed at the front side of the seat 100a, at both sides of the front part of the seat 100a, or at armrests on both sides of the seat 100a, and the present disclosure is not limited thereto. Preferably, two rotary locking indicating mechanisms 120a are provided to be disposed on both sides of the seat 100a.

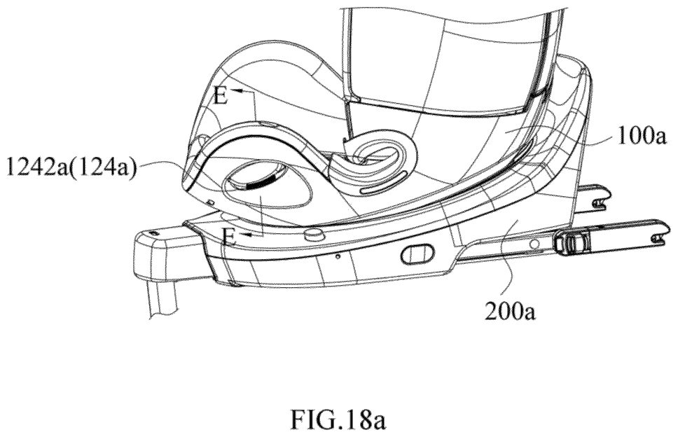

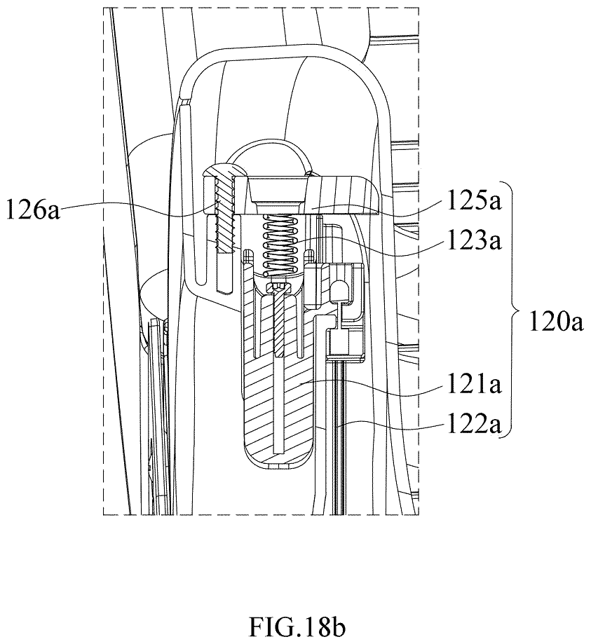

Specifically, the rotary locking indicating mechanism 120a includes an unlocking operating element 121a, an unlocking traction element 122a and a state indicator 124a. The unlocking operating element 121a is slidably connected to the seat 100a and is configured to be switched between a first position (as shown in FIG. 17b) and a second position (as shown in FIG. 18b) for releasing the locking of the seat 100a with respect to the base 200a. Preferably, the unlocking operating element 121a may be an unlocking button, which is disposed on either of two sides of the seat 100a in an inverted manner, and may be moved from the first position to the second position by being pressed in a substantially vertical direction, wherein the first position means that the unlocking button is located at a lower position, and the second position means that the unlocking button is pressed upward and located at an upper position.

In other embodiments, the unlocking operating element may also be disposed on the seat and may move in the front-back direction or the left-right direction with respect to the seat, or the unlocking operating element may also be disposed on the base.

One end of the unlocking traction element 122a is connected to the unlocking operating element 121a, while the other end of the unlocking traction element 122a is connected to the rotary locking mechanism 110a, specifically to the locking element 111a of the rotary locking mechanism 110a. For example, the unlocking traction element 122a may be an unlocking steel wire, but the present disclosure is not limited thereto. In this illustrated embodiment, the traction element 122a of the unlocking and the traction element 112a of the rotary locking mechanism 110a are integrated.

In one embodiment, the state indicator 124a is disposed at least on the unlocking operating element 121a to indicate the rotation locking state of the seat 100a with respect to the base 200a. When the seat 100a is locked to the base 200a by the rotary locking mechanism 110a, the unlocking operating element 121a is in the first position under the action of the unlocking traction element 122a, and the state indicator 124a indicates a first state; and when the unlocking operating element 121a is operated to shift from the first position to the second position, the unlocking operating element 121a drives the unlocking traction element 122a to unlock the seat 100a, and the state indicator 124a indicates a second state.

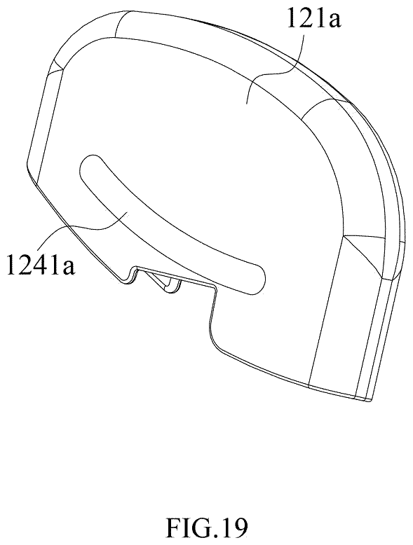

In an example, the state indicator 124a includes a first indicating element 1241a. As shown in FIGS. 17a and 19, the first indicating element 1241a is provided on an outer surface of the unlocking operating element 121a. When the seat 100a is locked to the base 200a, the unlocking operating element 121a is kept in the first position by the unlocking traction element 122a, and the first indicating element 1241a is exposed, as shown in FIG. 17a.

For example, when the unlocking operating element 121a is an unlocking button, the first indicating element 1241a may be disposed at an upper edge of the unlocking button corresponding to a pressing direction of the unlocking button, that is, as long as the first indicating element 1241a may be exposed when the seat 100a is locked to the base 200a. For another example, the unlocking button is disposed in an opening on the housing of the seat 100a (for example, the lower cover 101a), and a receiving portion for installing the unlocking button and receiving the pressed unlocking button is also disposed on the housing of the seat 100a. The first indicating element 1241a is disposed on the unlocking button near the position where the unlocking button is connected and cooperated with the housing of the seat 100a (that is, on the unlocking button and close to the receiving portion of the housing of the seat 100a). When the unlocking button is pressed, the unlocking button is at least partially pressed into the receiving portion, so that the first indicating element 1241a is subsequently pressed into the receiving portion to be shielded by the housing of the seat.

Furthermore, the first indicating element 1241a may be a protrusion or a recess provided on the outer surface of the unlocking operating element 121a, may be integrally formed with the unlocking operating element 121a, or may be designed to fit a shape of an opening of the lower cover 101a of the seat 100a. The first indicating element 1241a may also be a green pad printing or have another color and shape, and the present disclosure is not limited thereto.

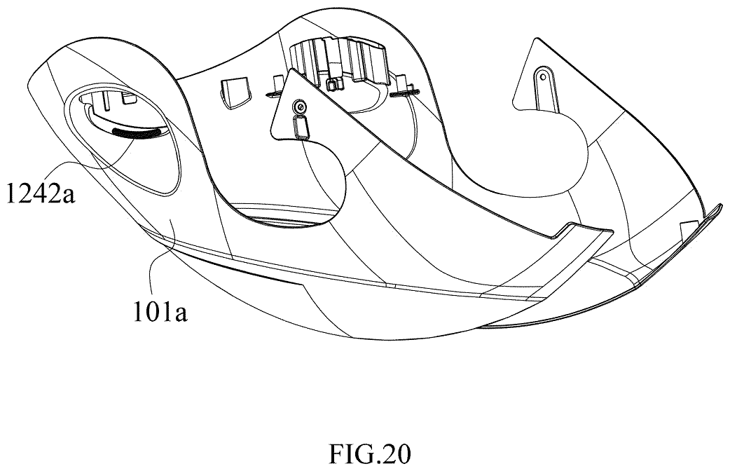

In addition, the state indicator 124a may further include a second indicating element 1242a. As shown in FIGS. 17b and 20, the second indicating element 1242a is provided on the outer surface of the seat 100a (for example, the lower cover 101a), and may also be provided on the outer surface of the unlocking operating element. When the seat 100a is locked to the base 200a, the first indicating element 1241a is exposed, but the second indicating element 1242a is shielded by the unlocking operating element 121a; and when the unlocking operating element 121a is operated to the second position, the first indicating member 1241a is shielded by the seat 100a, and the second indicating member 1242a is exposed, as shown in FIG. 18a.

For example, when the unlocking operating element 121a is an unlocking button, the second indicating element 1242a may be provided at the lower edge of the unlocking button corresponding to the pressing direction of the unlocking button, or at a position corresponding to the unlocking button on the lower cover 101a of the seat 100a, for example, at a lower inner surface of the opening (for accommodating the unlocking button) of the lower cover 101a.

In addition, the second indicating element 1242a may be a protrusion or a recess disposed on the outer surface of the lower cover 101a, may be integrally formed with the lower cover 101a, or may be designed to fit the shape of the unlocking button. The first indicating element 1241a may also be a red pad printing or have other colors and shapes, and the present disclosure is not limited thereto.

When the state indicator 124a includes both the first indicating element 1241a and the second indicating element 1242a, the first indicating element 1241a and the second indicating element 1242a may display different indication information, such as different colors. For example, when the first indicating element 1241a is a green pad printing to show that the seat 100a is locked to the base 200a, the second indicating element 1242a may have a color significantly different from that of the first indicating element 1241a, such as a red pad printing, to reminder the user of the switching of states.

In another embodiment, the state indicator 124a may also be provided only on the seat 100a (for example, the lower cover 101a). For example, the state indicator 124a may only include a second indicating element 1242a provided on the lower cover 101a, and the second indicating element 1242a is shielded when the seat 100a is locked to the base 200a; and the second indicating element 1242a is exposed when the locking between the seat 100a and the base 200a is released, so as to indicate the current state of the child safety seat to the user.

That is, the state indicator 124a of the present disclosure may be provided on at least one of the unlocking operating element 121a and the seat 100a (such as the lower cover 102a).

In addition, as shown in FIGS. 17b and 18b, the rotary locking indicating mechanism 120a further includes an unlocking elastic reset element 123a. One end of the unlocking elastic reset element 123a is connected to the seat 100a, and the other end of the unlocking elastic reset element 123a is connected to the unlocking operating element 121a, so as to provide a force for driving the unlocking operating element 121a to be in the second position, thereby pulling the unlocking traction element 122a to tend to be away from the rotary locking mechanism 110a, that is, pulling the locking element 111a of the rotary locking mechanism 110a. The force exerted by the unlocking elastic reset element 123a on the unlocking operating element 121a and thus on the unlocking traction element 122a is smaller than the locking force provided by the rotary locking mechanism 110a (that is, the locking element 111a), that is, the force exerted by the unlocking elastic reset element 123a on the unlocking operating element 121a and thus on the unlocking traction element 122a is smaller than a force of the rotary locking mechanism 110a to pull the unlocking traction element 122a as one of the locking element 111a is kept protruding from the fixing structure 114a under the action of the elastic reset element 113a when the child safety seat la is in the forward or backward-facing state. For example, the unlocking elastic reset element 123a is a tension spring, one end of which is fixedly disposed on the unlocking operating element 121a by a screw (that is, the end may move along with the unlocking operating element 121a), and the other end of which is fixed (that is, immovable) with respect to the seat 100a.

For the convenience of understanding, the following description will take the unlocking operating element 121a as the unlocking button and the unlocking elastic reset element 123 as the tension spring as an example. With reference to FIGS. 14b, 17a, 17b and 19, the unlocking button is invertedly disposed on the seat 100a. When the seat 100a is locked to the base 200a, the locking element 111a of the rotary locking mechanism 110a is inserted into the forward positioning hole 2011a (or the backward positioning hole 2012a) under the action of the elastic reset element 113a, and the unlocking traction element 122a is pulled to downwardly limit the unlocking button to the first position (i.e., the unlocking button is located at the lower position). Since a pulling force of the tension spring is smaller than that of the unlocking traction element 122a, the tension spring is elongated, and at this time, the unlocking button is located at the lower position to shield the second indicating element 1242a and expose the first indicating element 1241a disposed at the upper part of the outer surface of the unlocking button, thereby indicating that the seat 100a has been locked to the base 200a. When there is a need to rotate the seat 100a, the unlocking button is pressed to move upward with respect to the lower cover 101a, and the unlocking traction element 122a is pulled upward to pull the locking element 111a out of the forward positioning hole 2011a (or the backward positioning hole 2012a). When the seat 100a has rotated away from the forward use position or the backward use position with respect to the base 200a, the locking element 111a at the other end of the unlocking traction element 122a is held by the inner surface of the base 200a and kept in the retracted state; at the same time, if the unlocking button is released, since the pulling force of the tension spring is greater than that of the unlocking traction element 122a, the unlocking button is moved to the second position (located at the upper position) under a contraction force of the tension spring, and the unlocking button may be positioned to the second position. At this state, the first indicating element 1241a disposed on the outer surface of the unlocking button is shielded, for example, hidden in the lower cover 101a, while the second indicating element 1242a located on the lower cover 101a is exposed, thereby indicating that the seat 100a is unlocked to rotate with respect to the base 200a. Therefore, the rotary locking indicating mechanism 120a of the present disclosure may display and hide the two indicating elements by the up and down movement of the unlocking button, so as to indicate whether the seat 100a is locked to the base 200a. Of course, as described above, only one of the first indicating element 1241a and the second indicating element 1242a may be provided. For example, when only the first indicating element 1241a is disposed on the outer surface of the unlocking button, a state of that the first indicating element 1241a is exposed means that the seat is locked to the base, while a state of that the first indicating element 1241a is blocked means that the locking of the seat is released.

Furthermore, as shown in FIGS. 17b and 18b, the rotary locking indicating mechanism 120a may further include a fixing element 125a fixedly connected to the seat 100a by, for example, a screw 126a, and the unlocking operating element 121a is slidably disposed on the fixing element 125a to slide between the first position and the second position with respect to the seat 100a.

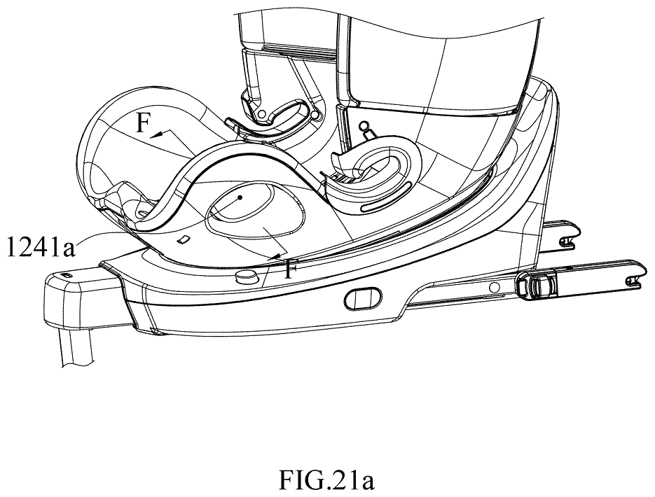

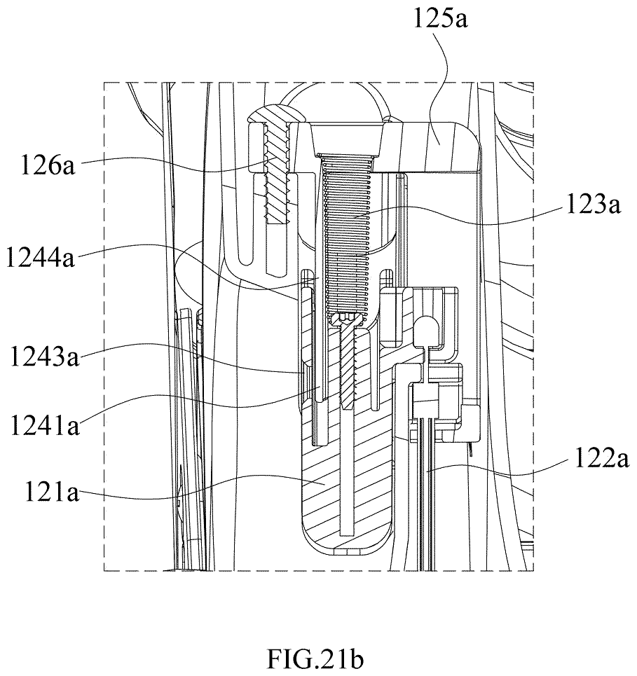

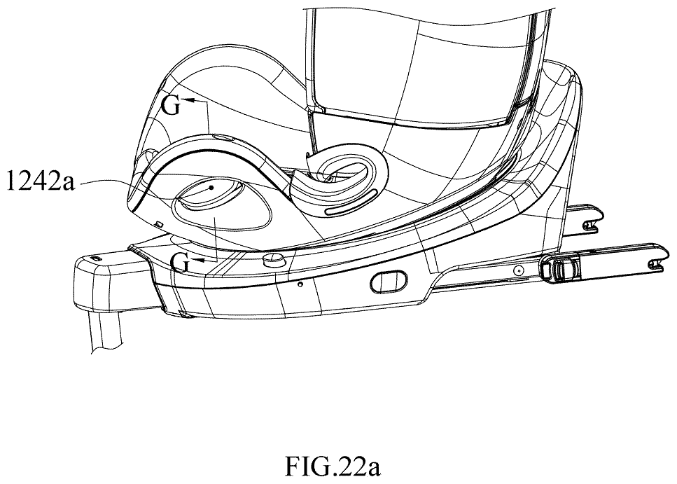

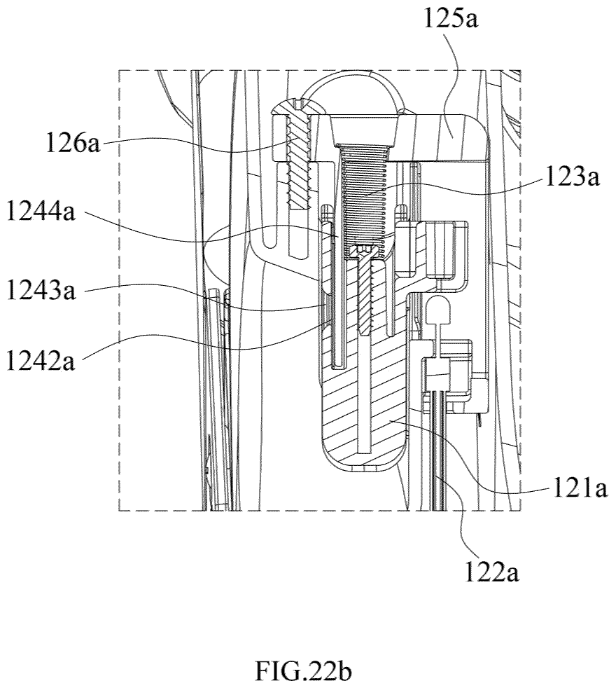

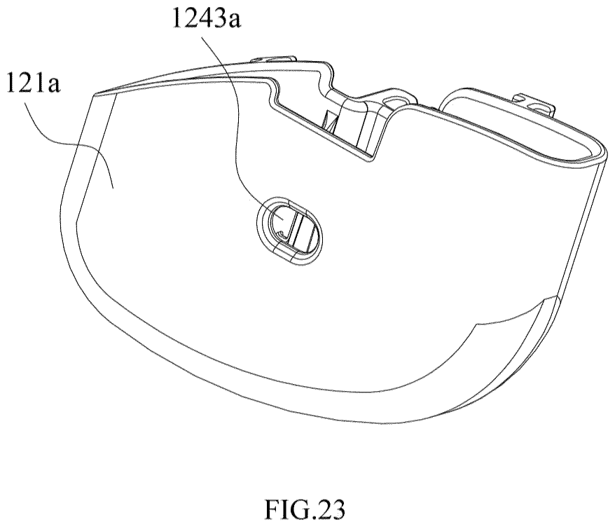

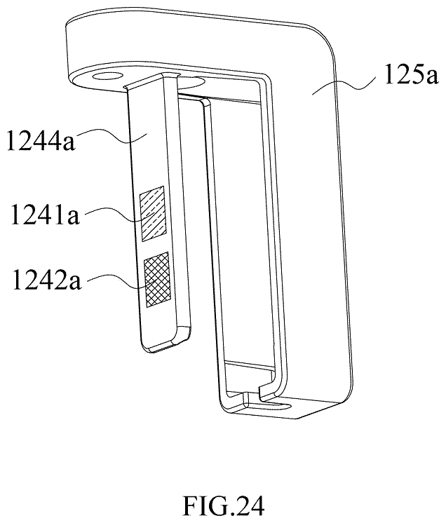

FIGS. 21a to 24 illustrate the rotary locking indicating mechanism according to another embodiment of the present disclosure.

In another embodiment of the present disclosure, the state indicator may include an indicating window and an indicating member disposed at a rear side of the indicating window, wherein one of the indicating window and the indicating member is fixedly disposed on the seat 100a, and the other of the indicating window and the indicating element is disposed on the unlocking operating element 121a, such as the unlocking button. For example, as shown in FIGS. 21a to 24, the state indicator 124a includes a first indicating element 1241a, a second indicating element 1242a, an indicating window 1243a and an indicating bar 1244a, and the first indicating element 1241a, the second indicating element 1242a and the indicating bar 1244a constitute the indicating member as described above. The indicating bar 1244a is fixedly disposed on the seat 100a by means of bolt fixing, welding, bonding and the like, or may also be fixedly disposed on the fixing element 125a fixedly connected with the seat 100a. As shown, the indicating bar 1244a is integrally formed with the seat 100a (or the fixing element 125a). The first indicating element 1241a and the second indicating element 1242a are disposed on the indicating bar 1244a along the moving direction (e.g., vertical direction) of the unlocking operating element 121a, and the indicating window 1243a is disposed on the unlocking operating element 121a. In this embodiment, the indicating bar 1244a is inserted into the unlocking operating element 121a, and the unlocking operating element 121a may move with respect to the fixing element 125a and further with respect to the indicating bar 1244a. When the unlocking operating element 121a is located at the first position, the indicating window 1243a exposes the first indicating element 1241a; and when the unlocking operating element 121a is moved to the second position, the indicating window 1243a exposes the second indicating element 1242a, wherein the first indicating element 1241a and the second indicating element 1242a display different indicating information. For example, the first indicating element 1241a is shown as green and the second indicating element 1242a is shown as red, so as to indicate different states of the seat 100a.

For the convenience of understanding, the following description will take the unlocking operating element 121a as an example again. When the seat 100a is locked to the base 200a, the unlocking operating element 121a (unlocking button) is located at the first position (i.e., the unlocking button is located at the lower position), and the indicating window 1243a on the unlocking operating element 121a shows the first indicating element 1241a (located above the second indicating element 1242a) on the indicating bar 1244a; and when the unlocking operating element 121a (unlocking button) is located at the second position (i.e., the unlocking button is located at the upper position), the indicating window 1243a on the unlocking operating element 121a shows the second indicating element 1242a on the indicating bar 1244a, so that the indicating elements with different information (e.g., different colors) can be realized by changing the position of the unlocking button in the up and down direction, thereby indicating the state of the seat 100a with respect to the base 200a.

Through the rotary locking indicating mechanism 120a of the present disclosure, the user can intuitively and clearly know whether the seat 100a of the child safety seat is positioned in place and locked to the base 200a from the external of the seat 100a, so as to determine whether the child safety seat is used safely, thereby providing a better user experience and improving the use safety. Moreover, the state indicator 124a is disposed at least on the unlocking operating element 121a and indicates different states, simplifying the overall structure of the seat 100a, thereby reducing the production and processing cost, optimizing the assembly process, and making the operation convenient.

According to some embodiments, the present disclosure provides rotary locking indicating mechanism which can indicate a rotary locking state of a child safety seat.

According to some embodiments, the present disclosure provides a rotary locking indicating mechanism with simple structure, convenient operation and high use safety.

According to some embodiments, the present disclosure provides a child safety seat that enables users to know clearly whether the child safety seat is rotationally positioned in place.

The present disclosure has at least one of the following beneficial effects:

The child safety seat of the present disclosure can prevent the seat from being wrongly rotated. In particular, the child safety seat of the present disclosure requires additional operation to allow the seat to rotate from the backward-facing state to the forward-facing state, and does not block the seat from normally rotating from the forward-facing state to the backward-facing state. The additional operation is convenient to be performed from either side of the child safety seat. The structure of the anti-misuse mechanism of the child safety seat is simple and has good reliability, and the locking element of the anti-misuse mechanism has high running quality and is not easy to shake.

In the present disclosure, the support leg is provided to have at least an unfolded position and a folded position, so that when the child safety seat for the vehicle is used, the child safety seat is well supported by the support leg to prevent the child safety seat from being overturned; and when it is not in use, the support leg may be folded at the bottom of the base to facilitate storage, and at the same time, the volume of the child safety seat can be reduced to reduce the transportation cost. In addition, providing a sliding element telescopically disposed on the base, and pivoting the support leg on the sliding element to extend and retract with the sliding element, not only facilitates to install the support leg, but also can pivot well and extend or retract with extending or retracting of the sliding element, so that when the support leg is not used, the sliding element may be retracted to the bottom of the base to reduce the length of the sliding element protruding from the front end of the base or avoid the sliding element from protruding from the base, thereby not affecting the feet of the child, improving the riding experience of the child, further reducing the volume of the child safety seat, and thus reducing the transportation cost. In addition, a traction element is provided to be tightened when the support leg is pivoted and folded, so as to form an inward reaction force, so that the support leg may retract inward synchronously, that is, retract in a direction close to the base, and the user does not need to push the support leg to retract after the support leg is folded, thereby achieving a complete folding, simplifying the operation of the user, making the operation simple and convenient, providing a good user experience and high satisfaction, forming differentiation from the existing products, and greatly improving the market competitiveness of products.

The traction element is provided as a flexible element, so that the traction element has certain flexibility and bending flexibility, which is convenient for the winding deformation of the traction element. In this way, the support leg may be well retracted inward when being folded, ensuring the retraction effect of the support leg, that is, the retraction effect of the sliding element; and when the support leg needs to be folded by the user, the present disclosure provides a simple and effortless operation, greatly improving the use experience of the user.

The flexible element is provided as a steel wire, not only ensuring the strength of the traction element to avoid being broken off by pulling, but also improving the durability, ensuring the good flexibility and deflection, and forming a good inward reaction force when the support leg is pivoted and folded, so that the support leg may be retracted inward; alternatively, the flexible element may also be provided as a string or a woven tape, so that the support leg may be retracted inward when the support leg is pivoted and folded, that is, the support leg may be retracted inward synchronously when it is pivoted and folded, simplifying the operation of the user, and reducing the overall cost of the child safety seat as the material cost of the string or the woven tape is low.

The driving element is provided to pivot along with the support leg, so that the traction element forms a good reaction force when the support leg is pivoted and folded, that is, the driving element forms a certain rolling on the traction element to better pull the support leg to retract inward and enable the support leg to be completely folded. In this way, the sliding element will not protrude too far from the front end of the base to affect the riding experience of children, improve the use experience of the child safety seat, reduce the volume of the child safety seat during transportation, and reduce the transportation cost.

The driving element is provided on the support leg to facilitate the driving element to pivot along with the support leg, and the driving element is integrated with the support leg and serves as a part of the support leg, ensuring the strength and durability of the driving element and prolonging the service life; alternatively, the driving element and the support leg are separately formed and may be connected and fixed through a fixing structure, so as to facilitate the structure and position arrangement of the driving element without being limited by the structure and position, and provide a more flexible structural design.

The driving element is provided on the upper end of the support leg, so that when the support leg is pivoted and folded, the support leg may be retracted by pivoting at a small angle, not only saving the applied force when the support leg is pivoted and folded, but also reducing the length of the traction element, thereby reducing the material cost and the overall production cost.

The driving element is provided in a boss shape and provided with an arc part cooperated with the traction element, so that the driving element may form a better rolling effect on the traction element when the support leg is pivoted and folded, and the traction element may form a greater inward reaction force to retract the support leg inward and ensure the retraction effect of the support leg, that is, the retraction effect of the sliding element; alternatively, the driving element may be provided in a shape of a pulley or a column, so that the driving element may form a better rolling effect on the traction element, that is, the traction element is forced to generate enough reaction force to pull the support leg to retract, and have a good retraction effect.

The first end of the traction element is fixedly connected with the base, and the second end of the linkage element is fixedly connected with the driving element, so that one end of the traction element is fixedly disposed, and the other end thereof is movably disposed, so that the other end of the traction element is rolled and tightened by the driving element when the support leg is pivoted, and the traction element is forced to ensure that when the traction element is forced by the driving element to pivot outwards, a reaction force for pulling the support leg to retract inwards can be formed, thereby ensuring that the support leg may retract synchronously when being pivoted and folded, and the traction element is stressed stably and reliably and is not easily broken, and the support leg may be retracted by being pivoted at a small angle. Alternatively, the second end of the traction element may be directly fixed to the upper end of the support leg, so that the support leg directly drives the traction element when the support leg is pivoted and folded, and under the action of the driving element, the traction element is tightened to form a reaction force, so as to realize synchronous inward retraction when the support leg is pivoted and folded.

The fixing column is disposed on the base, and the first end of the traction element is fixed with the base through the cooperation of the fastener and the fixing column. This fixing method is simple, reliable and not easy to loosen, so as to ensure the action effect of the traction element.

The stroke amplifying mechanism is provided, and the first end of the stroke amplifying mechanism is connected with the base, and the second end of the stroke amplifying mechanism is connected with the support leg through the traction element, so that when the support leg is pivoted and folded, the traction element is driven to drive the stroke amplifying mechanism, and then the stroke amplifying mechanism drives the support leg to retract inward, so that the support leg retracts inward synchronously when it is folded, which is convenient for operation and increases the inward retraction length of the support leg to meet better use requirements.

The rhombic telescopic frame is used to provide not only a good telescopic effect to ensure the retraction effect of the support leg, but also a large telescopic change of the rhombic telescopic frame, that is, it may be extended to be in a long length and retracted to be in a short length, which can enlarge the stroke better, especially the effect of retracting the support leg is greatly enhanced, and at the same time, it is strong enough and is not easy to deform or loosen when the support leg is pulled. Secondly, the rhombic telescopic frame has a simple structure, which is convenient for production and assembly, and improves the production and assembly efficiency. Specifically, the rhombic telescopic frame is composed of a plurality of rhombic structures, and the rhombic structures includes a plurality of sets of two connecting rod assemblies hinged at the middle position thereof and connected with each other, so as to ensure the action effect of the rhombic telescopic frame and facilitate the production and assembly of the rhombic telescopic frame.

The fixing frame is provided to facilitate reliable fixing between the stroke amplifying mechanism and the base, and ensure the stability and reliability of the stroke amplifying mechanism when it is extended and retracted.

According to the child safety seat of the present disclosure, when the support leg is pivoted and folded, the traction element is tightened to form an inward reaction force, so that the support leg is synchronously retracted inward, thereby providing a simple and convenient operation and a saved volume.

The sliding element is provided and the support leg is pivotally connected to the sliding element, so that the support leg may be unfolded or folded along with extending and retracting of the sliding element, and the safety seat can achieve good safety when being unfolded and small size when being folded in both use modes. In the first use mode, the seat is backward and the support leg is unfolded, or the seat is forward and the support leg is unfolded; and in the second use mode (i.e., booster mode), the seat is forward and the support leg is folded. In the first use mode, the seat may be used backwards with the unfolded support leg, or used forwards with the unfolded support leg. More specifically, the use mode in which the seat is used backwards with the unfolded support leg is suitable for children younger than 15 months and/or with a height of 0-105 cm, and the use mode in which the seat is used forwards with the unfolded support leg is suitable for children older than 15 months and/or with a height of 76 cm-105 cm, that is, a young children mode. In the second use mode (booster mode), the seat needs to be forward and the support leg need to be folded before use. This mode is suitable for children with a height between 100 cm and 150 cm, that is, an old children mode.

In the first use mode, the support leg is extended or retracted to adjust a grounding position of the support leg after it is unfolded, ensuring a proper position of the upper end of the support leg supported on the base, forming a good support for the safety seat so that the safety seat can be well prevented from being overturned, and ensuring the safety when the safety seat is used; at the same time, the rear row seat of the vehicle has enough space, forming a good buffering effect when the vehicle is impacted due to the sufficient front and rear spaces, and providing a good protection for young children and a large space for installing the safety seat conveniently and facilitating to put the young children in or out. Moreover, in the second use mode, that is, when the support leg is not needed, the support leg may be folded and hidden under the base, and then installed on the vehicle seat for the old children to use. Considering that the old children are generally taller than the young children, and thus more space are required, the present disclosure not only increases the space of the rear row seat of the vehicle to meet the sitting space of the old children, but also forms a better buffering when the vehicle is impacted since the front and rear spaces are large enough, so as to provide a better protection for the old children, at the same time, make room for the old children to put his/her feet, improve the comfort of riding the safety seat, and ensure the safety and stability of the old children when the safety seat is used for the old children; and the support leg is hidden when it is not used, reducing the overall size of the safety seat, reducing the packaging volume of the safety seat and thereby reducing the transportation cost. In addition, with extension and retraction of the sliding element, i.e., the support leg, the overall size of the safety seat can be changed. The size of the rear row space is different due to different types of vehicles, and the present disclosure may adapt to different types of vehicles, greatly improving the application scope of the safety seat. At the same time, this safety seat can realize two use modes, i.e., a use mode for young children and a use mode for old children, that is, a multi-functional seat, thereby greatly improving the application scope of the safety seat, so that the user can only buy one safety seat to realize multiple functions, greatly reducing the usage cost of the user to provide a better attraction on the users, forming product differentiation, and greatly enhancing the market competitiveness of products.

Compared with the prior art, in the rotary locking indicating mechanism provided by the present disclosure, the state indicator is at least provided on the unlocking operating element to indicate the first state and the second state when the unlocking operating element is in the first position and the second position respectively, so as to provide information about whether the seat of the child safety seat has been positioned in place and locked to the base to the user, thereby providing a better user experience for the user; at the same time, the rotary locking indicating mechanism in the present disclosure can also prevent the safety risk caused by the child safety seat not being locked in place, thereby improving the use safety. In addition, the rotary locking indicating mechanism has the advantages of simple structure, convenient operation, low cost, convenient production, processing and assembly, and further reduced maintenance cost.

Although relative terms, such as “on” and “under”, are used in this specification to describe the relative relationship between one component and another component in the drawings, these terms are used in this specification only for convenience, for example, according to directions of the examples described in the drawings. It can be understood that if the device shown is turned upside down, the component described as being “on” another component will become the component described as being “under” another component. Other relative terms such as “top”, “bottom”, “left” and “right” have similar meanings. When a structure is “on” other structure(s), it may mean that the structure is integrally formed on other structure(s), or that the structure is “directly” disposed on other structure(s), or that the structure is “indirectly” disposed on other structure(s) through another structure.

In this specification, the terms “a”, “an”, “the”, “said” and “at least one”, are used to express the presence of one or more the element/component/or the like. The terms “comprise”, “include” and “have” are intended to be inclusive, and mean there may be additional elements/constituents/or the like other than the listed elements/components/or the like. The “first”, “second” and “third” are used only as marks, and are not numerical restriction to the objects.

Unless otherwise defined, all terms including technical and scientific terms used herein have the same meaning as commonly understood by one of ordinary skill in the art to which this disclosure belongs. It should also be understood that a term should be interpreted as having a meaning consistent with its meaning in the context of the related art, and will not be interpreted as an idealized or overly formal meaning unless explicitly defined herein.

Other embodiments of the disclosure will be apparent to those skilled in the art from consideration of the specification and practice of the disclosure disclosed herein. This application is intended to cover any variations, uses, or adaptations of the disclosure following, in general, the principles of the disclosure and including such departures from the present disclosure as come within known or customary practice in the art to which the disclosure pertains. It is intended that the specification and examples be considered as exemplary only, with a true scope and spirit of the disclosure being indicated by the following claims.

Although the present disclosure has been described with reference to exemplary embodiments, the terminology used is illustrative and exemplary, rather than limiting. As the present disclosure can be embodied in various forms without departing from the spirit and essence of the present disclosure, it should be understood that the above-mentioned embodiments are not limited to any of the foregoing details, but should be interpreted as broadly as possible within the scope defined by the claims, and therefore all changes that fall within the scope of the claims or their equivalents should be covered by the claims.

1-14. (canceled)

15. A rotary locking indicating mechanism for indicating whether a seat of a child safety seat rotatable relative to a base is positioned, wherein the rotary locking indicating mechanism is disposed on the seat of the child safety seat and connected to a rotary locking mechanism for locking the seat to the base, and comprises:
an unlocking operating element slidably connected to the seat and capable of switching between a first position and a second position;
an unlocking traction element, one end of which is connected to the unlocking operating element, and the other end of which is connected to the rotary locking mechanism; and
a state indicator disposed at least on the unlocking operating element for indicating a rotary locking state of the seat with respect to the base,
wherein, when the seat is locked to the base through the rotary locking mechanism, the unlocking operating element is located at the first position under an action of the unlocking traction element, and the state indicator indicates a first state; and
when the unlocking operating element is operated to shift from the first position to the second position, the unlocking operating element drives the unlocking traction element to release the locking of the seat, and the state indicator indicates a second state.

16. The rotary locking indicating mechanism according to claim 15, wherein the unlocking operating element is an unlocking button, and the unlocking button is movable from the first position to the second position by being pressed in a substantially vertical direction.

17. The rotary locking indicating mechanism according to claim 15, wherein the rotary locking indicating mechanism further comprises:
an unlocking elastic reset element, one end of which is connected to the seat and the other end of which is connected to the unlocking operating element, the unlocking elastic reset element being configured to provide a force for driving the unlocking operating element to be in the second position, thereby pulling the unlocking traction element to tend to be away from the rotary locking mechanism.

18. The rotary locking indicating mechanism according to claim 17, wherein the unlocking elastic reset element is a tension spring.

19. The rotary locking indicating mechanism according to claim 18, wherein, when the seat is locked, a force exerted by the unlocking elastic reset element on the unlocking operating element and thus on the unlocking traction element is smaller than a locking force provided by the rotary locking mechanism.

20. The rotary locking indicating mechanism according to claim 15, wherein the state indicator comprises:
a first indicating element disposed on an outer surface of the unlocking operating element,
when the seat is locked to the base, the unlocking operating element is kept at the first position by the unlocking traction element, and the first indicating element is exposed.

21. The rotary locking indicating mechanism according to claim 20, wherein the state indicator further comprises:
a second indicating element disposed on an outer surface of the seat,
when the seat is locked to the base, the unlocking operating element shields the second indicating element;
when the unlocking operating element is operated to the second position, the first indicating element is shielded by the seat and the second indicating element is exposed,
wherein the first indicating element and the second indicating element display different indication information.

22. The rotary locking indicating mechanism according to claim 15, wherein the rotary locking indicating mechanism further comprises:
a fixing element fixedly connected to the seat, the unlocking operating element being slidably disposed on the fixing element to slide between the first position and the second position with respect to the seat.

23. The rotary locking indicating mechanism according to claim 22, wherein the state indicator comprises a first indicating element, a second indicating element, an indicating window and an indicating bar,
wherein the indicating bar is fixedly disposed on the fixing element, the first indicating element and the second indicating element are sequentially disposed on the indicating bar in a vertical direction, and the indicating window is disposed on the unlocking operating element, and
wherein, when the unlocking operating element is located at the first position, the indicating window exposes the first indicating element; and when the unlocking operating element is located at the second position, the indicating window exposes the second indicating element, and
wherein the first indicating element and the second indicating element display different indication information.

24. The rotary locking indicating mechanism according to claim 23, wherein the indicating bar is integrally formed with the fixing element, and the first indicating element and the second indicating element present different colors.

25. The rotary locking indicating mechanism according to claim 15, wherein the unlocking traction element is an unlocking steel wire.

26. The rotary locking indicating mechanism according to claim 15, wherein the rotary locking mechanism is disposed on the seat and is capable of being engaged with a corresponding positioning hole on the base.

27. The rotary locking indicating mechanism according to claim 26, wherein the positioning hole comprises a forward positioning hole and a backward positioning hole,
wherein, when the seat is in a forward-facing state, the rotary locking mechanism is engaged with the forward positioning hole; and when the seat is in a backward-facing state, the rotary locking mechanism is engaged with the backward positioning hole.

28. The rotary locking indicating mechanism according to claim 23, wherein the rotary locking mechanism comprises:
a fixing structure fixedly disposed on the seat, the fixing structure having an opened end,
a locking element disposed in the fixing structure, wherein the locking element is capable of sliding in the fixing structure, and one end of the locking element is configured to extend from the opened end of the fixing structure, so as to be engaged with the positioning hole; and
a traction element, one end of which is connected with the other end of the locking element, and the other end of which is connected with the unlocking operating element of the rotary locking indicating mechanism,
when one end of the locking element extends out of the fixing structure and is engaged with the positioning hole, the unlocking operating element is in the first position under an action of the traction element, and when the unlocking operating element is operated to shift from the first position to the second position, the locking element is retracted into the fixing structure through the traction element.

29. The rotary locking indicating mechanism according to claim 28, wherein the rotary locking mechanism further comprises:
an elastic reset element disposed between the fixing structure and the locking element and constantly providing a force for driving one end of the locking element to extend out of the fixing structure.

30. The rotary locking indicating mechanism according to claim 28, wherein the traction element and the unlocking traction element are integrated.

31-35. (canceled)
